(19) United States
(12) Patent Application Publication
(10) Pub. No.: US 2026/0332651 A1
(43) Pub. Date: Oct. 22, 2026

(54) CONTROLLING TRANSMISSION OF DATA WITHIN MULTI-TENANT SECURITY ENVIRONMENT

(71) Applicant: International Business Machines Corporation, Armonk, NY (US)

(72) Inventors: Dinesh C. Verma, New Castle, NY (US); Santosh Rajashekar, Bangalore (IN); Selvi John, Bangalore (IN)

(21) Appl. No.: 19/184,408

(22) Filed: Apr. 21, 2025

(51) Int. Cl. G06F 11/07; G06F 11/34

(52) U.S. Cl. CPC H04L 63/308; G06F 11/0709; H04L 1/0078

(57) ABSTRACT

Controlling transmission of data within a multi-tenant security environment includes receiving a set of resolution requests from a set of entities associated with a set of tenants of the multi-tenant security environment. The set of entities includes at least a first entity and a second entity. Resolution report data is obtained that includes a set of natural language texts associated with a set of resolutions for each resolution request of the set of resolution requests. The resolution report data is modified to structured resolution report data and structured entity data. A transmission of a first set of resolutions of the set of resolutions to a second entity is detected based on an application of a set of transmission policies on at least one of the structured resolution report data or the structured entity data. A transmission of the first set of resolutions to the first entity is controlled.

### BACKGROUND

The disclosure relates to data transmission control and more particularly, to data transmission control within computing environments.

With the advancement of computing technologies, the utilization of security environments (such as multi-tenant security environments) has increased to detect and resolve anomalies (such as cyber security attacks, hardware failures, and the like) within various entities associated with the multi-tenant security environments. The multi-tenant security environment includes suitable logic, circuitry, and/or interfaces for the execution of one or more security operations on data associated with various entities. The one or more security operations include a data monitoring operation, an anomaly detection operation, a resolution determination operation, a data transmission operation, and the like. In an example, the data monitoring operation includes an acquisition of entity performance data for each entity of various entities. The obtained entity performance data includes a set of identifiers associated with each entity of various entities, a processing time associated with each entity of various entities, an amount of memory usage associated with each entity of various entities, or a bandwidth associated with each entity of various entities. The set of identifiers includes an internet protocol address (such as 192. 168. 1.1) associated with each entity of various entities, a location (such as California) associated with each entity of various entities, and the like. In an example, a processing time of a first entity of various entities is 120 milliseconds. In an additional example, an amount of memory usage associated with the first entity of various entities is 220 megabytes. In yet additional example, a bandwidth associated with the first entity of various entities is 130 megabytes per second. The anomaly detection operation includes the detection of an occurrence of the anomalies within various entities based on the obtained entity performance data for each entity of various entities. The resolution determination operation includes a determination of resolutions to resolve the anomalies within various entities. The data transmission operation includes a transmission of the resolutions to various entities.

### SUMMARY

The following summary is provided for an understanding of some of the innovative features unique to the present disclosure and is not intended to be a full description. A full appreciation of the present disclosure may be gained by taking the entire specification, claims, drawings, and abstract as a whole.

In an embodiment of the disclosure, a computer-implemented method for controlling transmission of data within a multi-tenant security environment. The computer-implemented method further includes receiving, by a computer, a set of resolution requests from a set of entities associated with a set of tenants of a multi-tenant security environment. The set of entities includes at least a first entity associated with a first tenant of the set of tenants and a second entity associated with a second tenant of the set of tenants. The computer-implemented method further includes obtaining, by the computer, resolution report data including at least a set of natural language texts associated with a set of resolutions for each resolution request of the set of resolution requests and a set of identifiers for each entity of the set of entities. The resolution report data is obtained based on the reception of the set of resolution requests from the set of entities. The computer-implemented method further includes modifying, by the computer, the resolution report data to structured resolution report data including a first set of structured fields corresponding to the set of natural language texts associated with the set of resolutions. The computer-implemented method further includes modifying, by the computer, the resolution report data to structured entity data including a second set of structured fields corresponding to the set of natural language texts associated with the set of identifiers. The computer-implemented method further includes applying, by the computer, a set of transmission policies on at least one of the structured resolution report data or the structured entity data. The set of transmission policies is associated with a transmission of the set of resolutions to the set of entities. The computer-implemented method further includes detecting, by the computer, a transmission of a first set of resolutions of the set of resolutions to the second entity. The transmission of the first set of resolutions is detected based on the application of the set of transmission policies on the at least one of the structured resolution report data or the structured entity data. The first set of resolutions is associated with the first entity. The computer-implemented method further includes controlling, by the computer, a transmission of the first set of resolutions to the first entity. The transmission of the first set of resolutions is controlled based on the detection of the transmission of the first set of resolutions to the second entity.

In various embodiments of the disclosure, a computer system for controlling transmission of data within a multi-tenant security environment is provided. The computer system includes a processor set, one or more computer-readable storage media, and program instructions stored on the one or more computer-readable storage media. The program instructions are executable by the processor set to cause the processor set to receive a set of resolution requests from a set of entities associated with a set of tenants of a multi-tenant security environment. The set of entities includes at least a first entity associated with a first tenant of the set of tenants and a second entity associated with a second tenant of the set of tenants. The program instructions further cause the processor set to obtain resolution report data that includes at least a set of natural language texts associated with a set of resolutions for each resolution request of the set of resolution requests and a set of identifiers for each entity of the set of entities. The resolution report data is obtained based on the reception of the set of resolution requests from the set of entities. The program instructions further cause the processor set to modify the resolution report data to structured resolution report data that includes a first set of structured fields corresponding to the set of natural language texts associated with the set of resolutions. The program instructions further cause the processor set to modify the resolution report data to structured entity data that includes a second set of structured fields corresponding to the set of natural language texts associated with the set of identifiers. The program instructions further cause the processor set to apply a set of transmission policies on at least one of the structured resolution report data or the structured entity data. The set of transmission policies is associated with a transmission of the set of resolutions to the set of entities. The program instructions further cause the processor set to detect a transmission of a first set of resolutions of the set of resolutions to the second entity. The transmission of the first set of resolutions is detected based on the application of the set of transmission policies on the at least one of the structured resolution report data or the structured entity data. The first set of resolutions is associated with the first entity. The program instructions further cause the processor set to determine an occurrence of a transmission error associated with a transmission of the first set of resolutions to the first entity based on the detection of the transmission of the first set of resolutions to the second entity. The program instructions further cause the processor set to control the transmission of the first set of resolutions to the first entity based on the determination of the occurrence of the transmission error.

In various embodiments of the disclosure, a computer-program product for controlling transmission of data within a multi-tenant security environment is described.

Additional technical features and benefits are realized through the operations of the disclosure. Embodiments and aspects of the disclosure are described in detail herein and are considered a part of the claimed subject matter. For a better understanding, refer to the detailed description and the drawings.

### BRIEF DESCRIPTION OF DRAWINGS

The following description will provide details of preferred embodiments with reference to the following figures, wherein:

FIG. 1 is a diagram that illustrates a computing environment for controlling transmission of data within a multi-tenant environment, in accordance with an embodiment of the disclosure;

FIG. 2 is a diagram that illustrates an environment for controlling transmission of data within a multi-tenant security environment, in accordance with an embodiment of the disclosure;

FIG. 3 is a diagram that illustrates first exemplary operations for controlling transmission of data within a multi-tenant security environment, in accordance with an embodiment of the disclosure;

FIG. 4 is a diagram that illustrates second exemplary operations for controlling transmission of data within a multi-tenant security environment, in accordance with an embodiment of the disclosure;

FIG. 5A is a diagram that illustrates an exemplary first user interface for transmission of data, in accordance with an embodiment of the disclosure;

FIG. 5B is a diagram that illustrates an exemplary second user interface for controlling transmission of data within a multi-tenant environment, in accordance with an embodiment of the disclosure;

FIG. 6 is a diagram that illustrates a first flowchart of a method for controlling transmission of data within a multi-tenant security environment, in accordance with an embodiment of the disclosure; and

FIG. 7 is a diagram that illustrates a second flowchart of a method for controlling transmission of data within a multi-tenant security environment, in accordance with an embodiment of the disclosure.

### DETAILED DESCRIPTION

With the advancement of computing technologies, the utilization of security environments (such as multi-tenant security environments) has increased to detect and resolve anomalies (such as cyber security attacks, hardware failures, and the like) within various entities associated with the multi-tenant security environments. The multi-tenant security environment includes suitable logic, circuitry, and/or interfaces for the execution of one or more security operations on data associated with various entities. The one or more security operations include a data monitoring operation, an anomaly detection operation, a resolution determination operation, a data transmission operation, and the like. In an example, the data monitoring operation includes an acquisition of entity performance data for each entity of various entities. The obtained entity performance data includes a set of identifiers associated with each entity of various entities, a processing time associated with each entity of various entities, an amount of memory usage associated with each entity of various entities, or a bandwidth associated with each entity of various entities. The set of identifiers includes an internet protocol (IP) address (such as 192. 168. 1.1) associated with each entity of various entities, a location (such as California) associated with each entity of various entities, and the like. In an example, a processing time of a first entity of various entities is 120 milliseconds. In an additional example, an amount of memory usage associated with the first entity is 220 megabytes. In yet additional example, a bandwidth associated with the first entity is 130 megabytes per second. The anomaly detection operation includes the detection of an occurrence of the anomalies within various entities based on the obtained entity performance data for each entity of various entities. The resolution determination operation includes a determination of resolutions to resolve the anomalies within various entities. The data transmission operation includes a transmission of the resolutions to various entities.

However, ensuring data integrity within the multi-tenant security environment is challenging. In an example, the multi-tenant security environment is configured to process a large volume of data (such as resolution requests of various entities for the anomalies, the entity performance data of various entities, the resolutions for the anomalies, and the like). The large volume of data includes structured data (such as the IP address associated with each entity of various entities, the location associated with each entity of various entities, and the like). The large volume of data further includes unstructured data (such as a set of natural language texts corresponding to the resolutions for each resolution request of the resolution requests). Further, a presence of the unstructured data within the large volume of data increases the likelihood of an incorrect transmission of the resolutions to various entities. Moreover, the incorrect transmission of the resolutions increases a resolution time to resolve the anomalies within the various entities.

In an example, a manual processing of the large volume of data for the transmission of the resolutions to various entities is challenging. Specifically, the manual processing of the large volume of data including the unstructured data increases challenges associated with a determination of an association between the resolutions and various entities. Additionally, the manual processing of the large volume of data increases a likelihood of human errors (such as a provision of an incorrect identifier) for the transmission of the resolutions. Moreover, the incorrect transmission of the resolutions to the various entities leads to non-compliance with regulations associated with the transmission of the large volume of data. Examples of the regulations include, but are not limited to, a general data protection regulation (GDPR), a health insurance portability and accountability act (HIPPA), and a payment card industry data security standard (PCI DSS). The non-compliance further leads to legal disputes with various entities associated with the multi-tenant security environment. In an additional example, a variability of the structure of the unstructured data further increases challenges associated with the transmission of the resolutions to various entities. Specifically, the unstructured data may include a specific structure for each resolution, thereby increasing the challenges associated with the association between the resolutions and various entities. Hence, there is a need for a computer system to ensure data integrity within the multi-tenant security environment.

In operation, the computer system is configured to receive a set of resolution requests from a set of entities associated with a set of tenants of the multi-tenant security environment. The set of entities includes a first entity associated with a first tenant of the set of tenants and a second entity associated with a second tenant of the set of tenants. In an example, the first entity and the second entity correspond to a first user device and a second user device, respectively. Additionally, the first tenant and the second tenant correspond to a first business and a second business, respectively.

Each resolution request of the set of resolution requests is indicative of an occurrence of a set of anomalies (such as cyber-attacks, hardware failures, and the like) within the corresponding entity of the set of entities. In an example, the computer system is configured to receive a first resolution request and a second resolution request from the first entity and the second entity, respectively. In an example, the first resolution request includes a first set of request identifiers for the first entity. The first set of request identifiers includes a first set of identifiers 218A (a name of the first entity, an IP address of the first entity, and the like), timestamps (such as 1 Jan. 2025, 10:10:00) associated with the occurrence of a first set of anomalies of the set of anomalies within the first entity, an identifier associated with a type (such as a XYZ offense) associated with the first set of anomalies, and the like. Similarly, the second resolution request includes a second set of request identifiers for the second entity.

The computer system is configured to obtain resolution report data that includes at least a set of natural language texts associated with a set of resolutions for each resolution request of the set of resolution requests and a set of identifiers for each entity of the set of entities. In an embodiment of the disclosure, the computer system is configured to obtain the resolution report data based on the reception of the set of resolution requests from the set of entities. In an example, the computer system is configured to obtain the resolution report data as an output from a set of machine learning models. In an additional example, the computer system is configured to obtain the resolution report data as an input from a user (such as a technician, a security expert, and the like) associated with the multi-tenant security environment.

In an example, the resolution report data includes a first set of natural language texts of the set of natural language texts. The first set of natural language texts is associated with a first set of resolutions of the set of resolutions for the first resolution request. Further, the first set of natural language texts is associated with the first set of identifiers for the first entity. The first set of natural language texts corresponds to
“This ticket was created for a XYZ offense, where ThreatName:
PUP-XAC-DM—malware issue was identified on Feb. 12, 2017 on machine WLPKU15038L for client Resilient Systems.
We have instructed ABC-END_USER_PROTECTION_EMEA_ISMA_L2—ABC remedy support to update to the latest MNODAT/Definition and On-demand scan.
ABC remedy support team performed the steps but failed to attach the artifacts.
We have reviewed MNO_EPO logs for the past 7 days and found that the virus has been cleaned from the affected host.
The system is clean. Hence, we are closing this incident. We have attached a XYZ screenshot in the Resilient incident attachments”.

In an additional example, the resolution report data includes a second set of natural language texts of the set of natural language texts. The second set of natural language texts is associated with a second set of resolutions of the set of resolutions for the second resolution request. Further, the second set of natural language texts is associated with a second set of identifiers of the set of identifiers for the second entity. The second set of natural language texts corresponds to
“This ticket was created for a XYZ offense, where ThreatName:
PUP-XAC-DM—malware issue was identified on Feb. 12, 2017 on machine W7RU77185L for client Resilient Systems.
We have instructed ABC-END_USER_PROTECTION_EMEA_ISMA_L2—ABC remedy support to update to the latest MNODAT/Definition and On-demand scan.
ABC remedy support team performed the steps but failed to attach the artifacts.
We have reviewed MNO_EPO logs for the past 7 days and found that the virus has been cleaned from the affected host.
The system is clean. Hence, we are closing this incident. We have attached a XYZ screenshot in the Resilient incident attachments”.

The computer system is configured to modify the resolution report data to structured resolution report data. The structured resolution report data includes a first set of structured fields corresponding to the set of natural language texts associated with the set of resolutions. In an embodiment of the disclosure, the computer system is configured to apply the set of machine learning models on the resolution report data and the obtained entity performance data. Further, the computer system is configured to modify the resolution report data to the structured resolution report data based on the application of the set of machine learning models on the resolution report data and the obtained entity performance data.

In an example, the structured resolution report data includes a first set of structured fields for the first entity corresponding to the first set of natural language texts associated with the first set of resolutions. The first set of structured fields for the first entity corresponds to:

“
{“Identifier”: “PUP-XAC-DM”,
“Identifier”: “RID#001”,
“Timestamps”: “02/12/2017 10:10:00”,
“Identifier”: “USER#001”,
“Resolution Note”:
“We have instructed ABC-END_USER_PROTECTION_EMEA_ISMA_L2 - ABC remedy
support to update to the latest MNODAT/Definition and On-demand scan.
ABC remedy support team performed the steps but failed to attach the artifacts.
We have reviewed MNO_EPO logs for the past 7 days and found that the virus has been cleaned
from the affected host.
The system is clean. Hence, we are closing this incident. We have attached a XYZ screenshot in
the Resilient incident attachments”.
}
”

In an additional example, the structured resolution report data includes a first set of structured fields for the second entity corresponding to the second set of natural language texts associated with the second set of resolutions. The first set of structured fields for the second entity corresponds to:

“
{“Identifier”: “PUP-XAC-DM”,
“Identifier”: “RID#002”,
“Timestamps”: “02/12/2017 10:30:00”,
“Identifier”: “USER#001”,
“Resolution Note”:
We have instructed ABC-END_USER_PROTECTION_EMEA_ISMA_L2 - ABC remedy
support to update to the latest MNODAT/Definition and On-demand scan.
ABC remedy support team performed the steps but failed to attach the artifacts.
We have reviewed MNO_EPO logs for the past 7 days and found that the virus has been cleaned
from the affected host.
The system is clean. Hence, we are closing this incident. We have attached a XYZ screenshot in
the Resilient incident attachments”.
}

The computer system is configured to modify the resolution report data to the structured entity data. The structured entity data includes a second set of structured fields corresponding to the set of natural language texts associated with the set of identifiers. In an embodiment of the disclosure, the computer system is configured to apply the set of machine learning models on the resolution report data and the obtained entity performance data. Further, the computer system is configured to modify the resolution report data to the structured entity data based on the application of the set of machine learning models on the resolution report data and the obtained entity performance data.

In an example, the structured entity data includes a second set of structured fields for the first entity corresponding to the first set of natural language texts associated with the first set of identifiers. The second set of structured fields for the first entity corresponds to:

“
{“MachineName”: “W7PK15038L”,
“EventType”: “EPO_Malware”,
“AffectedIPAddress”: “10.235.146.179”,
“Location”: “Pakistan”,
“User”: {
“USERID”: “SESA409342”,
“Username”: “ABDUL RASHEED KHAN”
}
}
”

In an additional example, the structured entity data includes a second set of structured fields for the second entity corresponding to the second set of natural language texts associated with the second set of identifiers. The second set of structured fields for the second entity corresponds to:

“
{“MachineName”: “W7RU77185L”,
“EventType”: “XYZOffence”,
“Client”: {
“Name: “Resilient Systems”,
},
“AffectedIPAddress”: “Not Available (N/A)”,
“Location”: “N/A”,
“User”: “N/A”
}
}”

The modification of the resolution report data to the structured resolution report data and the structured entity data allows the computer system to apply a set of transmission policies on at least one of the structured resolution report data or the structured entity data. The set of transmission policies is associated with the transmission of the set of resolutions to the set of entities. The modification of the resolution report data allows the computer system to mitigate challenges associated with the manual processing of the large volume of data for the transmission of the resolutions to the set of entities. Specifically, the modification of the resolution report data allows the computer system to process the resolution report data that includes the set of natural languages for the determination of an association between the set of resolutions and the set of entities. Specifically, the modification of the resolution report data allows the computer system to process the resolution report data based on the first set of structured fields and the second set of structured fields, thereby mitigating the challenges associated with the variability of the structure of the unstructured data within the resolution report data.

The computer system is configured to apply the set of transmission policies on at least one of the structured resolution report data or the structured entity data. The set of transmission policies is associated with a transmission of the set of resolutions to the set of entities. In an embodiment of the disclosure, the application of the set of transmission policies on the structured resolution report data includes a comparison of the first set of structured fields with the set of request identifiers. Specifically, the computer system is configured to determine a set of request identifiers from the second resolution request of the set of resolution requests. The second resolution request is associated with the second entity. In an embodiment of the disclosure, the computer system is configured to determine the set of request identifiers from the second resolution request based on a transmission of the first set of resolutions to the second entity. The computer system is configured to compare a structured field of the first set of structured fields with a corresponding request identifier of the set of request identifiers. The structured field of the first set of structured fields is associated with the first entity.

In an example, the structured field of the first set of structured fields corresponds to a timestamp (02/12/2007 10:10:00) associated with an occurrence of an anomaly of the first set of anomalies within the first entity. The corresponding request identifier corresponds to a timestamp (02/12/2007 10:30:00) associated with an occurrence of an anomaly of the second set of anomalies within the second entity. The computer system is configured to determine that the structured field (02/12/2007 10:10:00) of the first set of structured fields is different from the corresponding request identifier (02/12/2007 10:30:00) of the set of request identifiers based on the comparison of the structured field (02/12/2007 10:10:00) of the first set of structured fields with the corresponding request identifier (02/12/2007 10:30:00) of the set of request identifiers.

In an embodiment of the disclosure, the application of the set of transmission policies on the structured entity data includes a comparison of the second set of structured fields with the set of request identifiers. Specifically, the computer system is configured to compare a structured field of the second set of structured fields with the corresponding request identifier of the set of request identifiers. The structured field of the second set of structured fields is associated with the first entity.

In an example, the structured field of the second set of structured fields corresponds to the location (Pakistan) of the first entity. The corresponding request identifier corresponds to the location (N/A) of the second entity. The computer system is configured to determine that the structured field (Pakistan) of the second set of structured fields is different from the corresponding request identifier (N/A) of the set of request identifiers based on the comparison of the structured field (Pakistan) of the second set of structured fields with the corresponding request identifier (N/A) of the set of request identifiers. The application of the set of transmission policies allows the computer system to decrease the likelihood of human errors (such as the provision of the incorrect identifier) for the transmission of the set of resolutions. Moreover, the application of the set of transmission policies allows the computer system to detect the incorrect transmission of the resolutions to the set of entities, thereby ensuring compliance with regulations associated with the transmission of the resolution report data.

The computer system is configured to detect a transmission of the first set of resolutions of the set of resolutions to the second entity. In an embodiment of the disclosure, the computer system is configured to detect the transmission of the first set of resolutions to the second entity based on the application of the set of transmission policies on the at least one of the structured resolution report data or the structured entity data. In an example, the computer system is configured to detect the transmission of the first set of resolutions to the second entity based on the determination that the structured field (02/12/2007 10:10:00) of the first set of structured fields is different from the corresponding request identifier (02/12/2007 10:30:00) of the set of request identifiers. In an additional example, the computer system is configured to detect the transmission of the first set of resolutions to the second entity based on the determination that the structured field (Pakistan) of the second set of structured fields is different from the corresponding request identifier (N/A) of the set of request identifiers.

The computer system is configured to control the transmission of the first set of resolutions to the first entity. The transmission of the first set of resolutions is controlled based on the detection of the transmission of the first set of resolutions to the second entity. In an embodiment of the disclosure, the computer system is configured to halt the transmission of the first set of resolutions to the second entity based on the detection of the transmission of the first set of resolutions to the second entity. The computer system is further configured to re-transmit the first set of resolutions to the first entity. The controlling of the transmission of the first set of resolutions to the first entity allows the computer system to ensure compliance with regulations associated with the transmission of the resolution report data.

In an embodiment of the disclosure, a computer-implemented method for controlling transmission of data within a multi-tenant security environment. The computer-implemented method further includes receiving, by a computer, a set of resolution requests from a set of entities associated with a set of tenants of a multi-tenant security environment. The set of entities includes at least a first entity associated with a first tenant of the set of tenants and a second entity associated with a second tenant of the set of tenants. The computer-implemented method further includes obtaining, by the computer, resolution report data including at least a set of natural language texts associated with a set of resolutions for each resolution request of the set of resolution requests and a set of identifiers for each entity of the set of entities. The resolution report data is obtained based on the reception of the set of resolution requests from the set of entities. The computer-implemented method further includes modifying, by the computer, the resolution report data to structured resolution report data including a first set of structured fields corresponding to the set of natural language texts associated with the set of resolutions. The computer-implemented method further includes modifying, by the computer, the resolution report data to structured entity data including a second set of structured fields corresponding to the set of natural language texts associated with the set of identifiers. The computer-implemented method further includes applying, by the computer, a set of transmission policies on at least one of the structured resolution report data or the structured entity data. The set of transmission policies is associated with a transmission of the set of resolutions to the set of entities. The computer-implemented method further includes detecting, by the computer, a transmission of a first set of resolutions of the set of resolutions to the second entity. The transmission of the first set of resolutions is detected based on the application of the set of transmission policies on the at least one of the structured resolution report data or the structured entity data. The first set of resolutions is associated with the first entity. The computer-implemented method further includes controlling, by the computer, a transmission of the first set of resolutions to the first entity. The transmission of the first set of resolutions is controlled based on the detection of the transmission of the first set of resolutions to the second entity.

In various embodiments of the disclosure, the computer-implemented method further includes determining, by the computer, an occurrence of a transmission error associated with the transmission of the first set of resolutions to the first entity based on the detection of the transmission of the first set of resolutions to the second entity. The computer-implemented method further includes controlling, by the computer, the transmission of the first set of resolutions to the first entity based on the determination of the occurrence of the transmission error.

In various embodiments of the disclosure, the computer-implemented method further includes obtaining, by the computer, entity performance data for each entity of the set of entities based on the reception of the set of resolution requests from the set of entities. The computer-implemented method further includes determining, by the computer, an occurrence of a set of anomalies within each entity of the set of entities based on the obtained entity performance data. The computer-implemented method further includes applying, by the computer, a set of machine learning models on the set of anomalies and the obtained entity performance data. The computer-implemented method further includes determining, by the computer, the resolution report data based on the application of the set of machine learning models on the set of anomalies and the obtained entity performance data.

In various embodiments of the disclosure, the obtained entity performance data includes at least one of the set of identifiers for each entity of the set of entities, a processing time associated with each entity of the set of entities, an amount of memory usage associated with each entity of the set of entities, or a bandwidth associated with each entity of the set of entities.

In various embodiments of the disclosure, the computer-implemented method further includes applying, by the computer, the set of machine learning models on the resolution report data and the obtained entity performance data. The computer-implemented method further includes modifying, by the computer, the resolution report data to the structured entity data based on the application of the set of machine learning models on the resolution report data and the obtained entity performance data.

In various embodiments of the disclosure, the computer-implemented method further includes applying, by the computer, a set of machine learning models on the resolution report data. The computer-implemented method further includes modifying, by the computer, the resolution report data to the structured resolution report data based on the application of the set of machine learning models on the resolution report data.

In various embodiments of the disclosure, the first set of structured fields and the second set of structured fields are associated with a set of data formats. The set of data formats includes at least one of a javascript object notation (JSON) format or an extensible markup language (XML) format.

In various embodiments of the disclosure, the first set of structured fields includes at least one of a structured field for an identifier of a set of anomalies associated with each entity of the set of entities, a structured field for an identifier of the set of resolutions associated with each entity of the set of entities, a structured field for a timestamp of an occurrence of the set of anomalies associated with each entity of the set of entities, or a structured field for an identifier of a user associated with the set of resolution requests.

In various embodiments of the disclosure, the second set of structured fields includes at least one of a structured field for an identifier of each entity of the set of entities, a structured field for an identifier of a respective tenant of each entity of the set of entities, or a structured field for an identifier of a location associated with each entity of the set of entities.

In various embodiments of the disclosure, the application of the set of transmission policies on the structured resolution report data includes determining, by the computer, a set of request identifiers from a resolution request of the set of resolution requests. The resolution request is associated with the second entity. The set of request identifiers is determined based on the transmission of the first set of resolutions to the second entity. The application of the set of transmission policies on the structured resolution report data further includes comparing, by the computer, a structured field of the first set of structured fields with a corresponding request identifier of the set of request identifiers. The structured field of the first set of structured fields is associated with the first entity. The application of the set of transmission policies on the structured resolution report data further includes determining, by the computer, that the structured field of the first set of structured fields is different from the corresponding request identifier of the set of request identifiers based on the comparison of the structured field of the first set of structured fields with the corresponding request identifier of the set of request identifiers. The application of the set of transmission policies on the structured resolution report data includes detecting, by the computer, the transmission of the first set of resolutions to the second entity based on the determination that the structured field of the first set of structured fields is different from the corresponding request identifier of the set of request identifiers.

The application of the set of transmission policies on the structured entity data includes comparing, by the computer, a structured field of the second set of structured fields with the corresponding request identifier of the set of request identifiers. The structured field of the second set of structured fields is associated with the first entity. The application of the set of transmission policies on the structured entity data further includes determining, by the computer, that the structured field of the second set of structured fields is different from the corresponding request identifier of the set of request identifiers based on the comparison of the structured field of the second set of structured fields with the corresponding request identifier of the set of request identifiers. The application of the set of transmission policies on the structured entity data further includes detecting, by the computer, the transmission of the first set of resolutions to the second entity based on the determination that the structured field of the second set of structured fields is different from the corresponding request identifier of the set of request identifiers.

The computer-implemented method further includes identifying, by the computer, a second set of resolutions from the set of resolutions based on the control of the transmission of the first set of resolutions to the first entity. The second set of resolutions is associated with the second entity. The computer-implemented method further includes controlling, by the computer, a transmission of the second set of resolutions to the second entity based on the identification of the second set of resolutions.

The computer-implemented method further includes generating, by the computer, an alert based on the detection of the transmission of the first set of resolutions to the second entity.

In various embodiments of the disclosure, a computer system for controlling transmission of data within a multi-tenant security environment is provided.

In various embodiments of the disclosure, a computer system for controlling transmission of data within a multi-tenant security environment is provided. The computer system includes a processor set, one or more computer-readable storage media, and program instructions stored on the one or more computer-readable storage media. The program instructions are executable by the processor set to cause the processor set to receive a set of resolution requests from a set of entities associated with a set of tenants of a multi-tenant security environment. The set of entities includes at least a first entity associated with a first tenant of the set of tenants and a second entity associated with a second tenant of the set of tenants. The program instructions further cause the processor set to obtain resolution report data that includes at least a set of natural language texts associated with a set of resolutions for each resolution request of the set of resolution requests and a set of identifiers for each entity of the set of entities. The resolution report data is obtained based on the reception of the set of resolution requests from the set of entities. The program instructions further cause the processor set to modify the resolution report data to structured resolution report data that includes a first set of structured fields corresponding to the set of natural language texts associated with the set of resolutions. The program instructions further cause the processor set to modify the resolution report data to structured entity data that includes a second set of structured fields corresponding to the set of natural language texts associated with the set of identifiers. The program instructions further cause the processor set to apply a set of transmission policies on at least one of the structured resolution report data or the structured entity data. The set of transmission policies is associated with a transmission of the set of resolutions to the set of entities. The program instructions further cause the processor set to detect a transmission of a first set of resolutions of the set of resolutions to the second entity. The transmission of the first set of resolutions is detected based on the application of the set of transmission policies on the at least one of the structured resolution report data or the structured entity data. The first set of resolutions is associated with the first entity. The program instructions further cause the processor set to determine an occurrence of a transmission error associated with a transmission of the first set of resolutions to the first entity based on the detection of the transmission of the first set of resolutions to the second entity. The program instructions further cause the processor set to control the transmission of the first set of resolutions to the first entity based on the determination of the occurrence of the transmission error.

In various embodiments of the disclosure, the program instructions further cause the processor set to obtain entity performance data for each entity of the set of entities based on the reception of the set of resolution requests from the set of entities. The program instructions further cause the processor set to determine an occurrence of a set of anomalies within each entity of the set of entities based on the obtained entity performance data. The program instructions further cause the processor set to apply a set of machine learning models on the set of anomalies and the obtained entity performance data. The program instructions further cause the processor set to determine the resolution report data based on the application of the set of machine learning models on the set of anomalies and the obtained entity performance data.

In various embodiments of the disclosure, the obtained entity performance data includes at least one of the set of identifiers for each entity of the set of entities, a processing time associated with each entity of the set of entities, an amount of memory usage associated with each entity of the set of entities, or a bandwidth associated with each entity of the set of entities.

In various embodiments of the disclosure, the program instructions further cause the processor set to apply the set of machine learning models on the resolution report data and the obtained entity performance data. The program instructions further cause the processor set to modify the resolution report data to the structured entity data based on the application of the set of machine learning models on the resolution report data and the obtained entity performance data.

In various embodiments of the disclosure, the program instructions further cause the processor set to apply a set of machine learning models on the resolution report data. The program instructions further cause the processor set to modify the resolution report data to the structured resolution report data based on the application of the set of machine learning models on the resolution report data.

In various embodiments of the disclosure, the first set of structured fields and the second set of structured fields are associated with a set of data formats. The set of data formats includes at least one of a javascript object notation (JSON) format or an extensible markup language (XML) format.

In various embodiments of the disclosure, a computer program product for controlling transmission of data within a multi-tenant security environment is provided.

The computer program product includes one or more computer-readable storage media. The program instructions are stored on the one or more computer-readable storage media to perform operations. The operations include receiving a set of resolution requests from a set of entities associated with a set of tenants of the multi-tenant security environment. The set of entities includes at least a first entity associated with a first tenant of the set of tenants and a second entity associated with a second tenant of the set of tenants. The operations include obtaining resolution report data including at least a set of natural language texts associated with a set of resolutions for each resolution request of the set of resolution requests and a set of identifiers for each entity of the set of entities. The resolution report data is obtained based on the reception of the set of resolution requests from the set of entities. The operations include modifying the resolution report data to structured resolution report data including a first set of structured fields corresponding to the set of natural language texts associated with the set of resolutions. The operations include modifying the resolution report data to structured entity data including a second set of structured fields corresponding to the set of natural language texts associated with the set of identifiers. The operations include applying a set of transmission policies on at least one of the structured resolution report data or the structured entity data. The set of transmission policies is associated with a transmission of the set of resolutions to the set of entities. The operations include detecting a transmission of a first set of resolutions of the set of resolutions to the second entity. The transmission of the first set of resolutions is detected based on the application of the set of transmission policies on the at least one of the structured resolution report data or the structured entity data. The first set of resolutions is associated with the first entity. The operations include controlling a transmission of the first set of resolutions to the first entity. The transmission of the first set of resolutions is controlled based on the detection of the transmission of the first set of resolutions to the second entity.

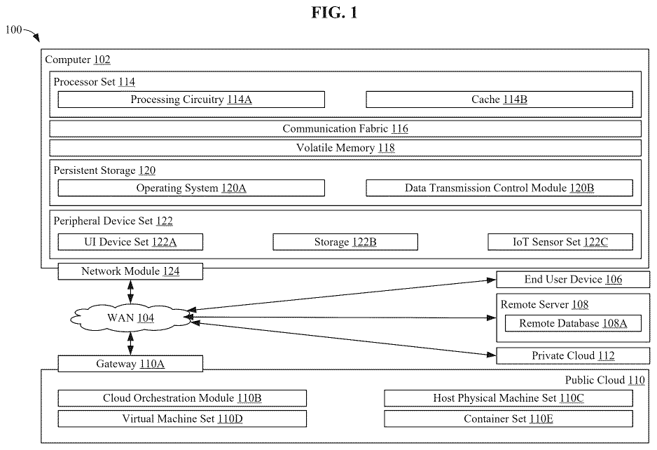

FIG. 1 is a diagram that illustrates a computing environment for controlling transmission of data within a multi-tenant environment, in accordance with an embodiment of the disclosure. With reference to FIG. 1, there is shown a computing environment 100 that contains an example of an environment for the execution of at least some of the computer code involved in performing the disclosed methods, such as a data transmission control module 120B. In addition to the data transmission control module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the data transmission control module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that can run a program, access a network or query a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the data transmission control module 120B in persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the data transmission control module 120B typically includes at least some of the computer code involved in performing the disclosed methods.

The peripheral device set 122 includes the set of peripheral devices of the computer 102. Data communication connections between the peripheral devices and the various components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, the storage 122B may take the form of a quantum computing storage device for storing data in the form of qubits. In embodiments of the disclosure where the computer 102 is needed to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with various computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through WAN 104 to the EUD 106. In this way, the EUD 106 can display, or otherwise present recommendations to an end user. In some embodiments of the disclosure, the EUD 106 may be a client device, such as a mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is shown as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

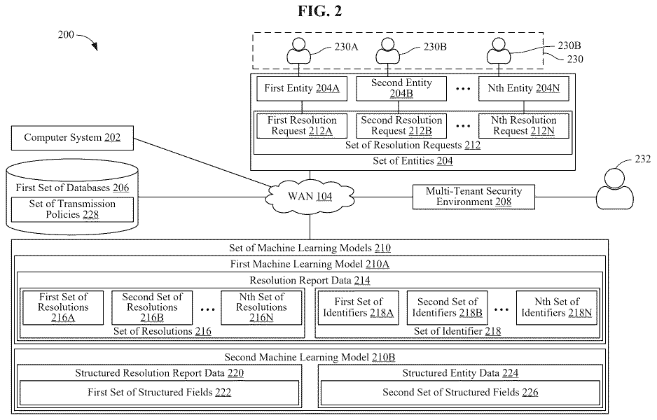

FIG. 2 is a diagram that illustrates an environment for controlling transmission of data within a multi-tenant security environment, in accordance with an embodiment of the disclosure. FIG. 2 is explained in conjunction with elements from FIG. 1. With reference to FIG. 2, there is shown a diagram of a network environment 200. The network environment 200 includes a computer system 202, a set of entities 204, a first set of databases 206, a multi-tenant security environment 208, and a set of machine learning models 210. The set of entities 204 is associated with the multi-tenant security environment 208. The set of entities 204 includes a first entity 204A, a second entity 204B, upto an Nth entity 204N. In an embodiment of the disclosure, the set of entities 204 is configured to transmit a set of resolution requests 212 that includes a first resolution request 212A, a second resolution request 212B, upto an Nth resolution request 212N. The set of machine learning models 210 includes a first machine learning model 210A and a second machine learning model 210B. In an example, the first machine learning model 210A is trained to determine resolution report data 214. The resolution report data 214 includes at least a set of natural language texts associated with a set of resolutions 216 for each resolution request of the set of resolution requests 212 and a set of identifiers 218 for each entity of the set of entities 204. The set of resolutions 216 includes a first set of resolutions 216A for the first resolution request 212A, a second set of resolutions 216B for the second resolution request 212B, upto an Nth set of resolutions 216N for the Nth resolution request 212N. The set of identifiers 218 includes a first set of identifiers 218A for the first entity 204A, a second set of identifiers 218B for the second entity 204B, upto an Nth set of identifiers 218N for the Nth entity 204N. In an example, the second machine learning model 210B is trained to modify the resolution report data 214 to structured resolution report data 220. The structured resolution report data 220 includes a first set of structured fields 222 corresponding to the set of natural language texts associated with the set of resolutions 216. In an additional example, the second machine learning model 210B is trained to modify the resolution report data 214 to structured entity data 224. The structured entity data 224 includes a second set of structured fields 226 corresponding to the set of natural language texts associated with the set of identifiers 218. The first set of databases 206 is configured to store a set of transmission policies 228 associated with a transmission of the set of resolutions 216 to the set of entities 204. With reference to FIG. 2, there is further shown a set of tenants 230 of the multi-tenant security environment 208, a user associated with the multi-tenant security environment 208, and the WAN 104 of FIG. 1. The set of tenants 230 includes a first tenant 230A, a second tenant 230B, upto an Nth tenant 230N. In an embodiment of the disclosure, the computer system 202 is an exemplary embodiment of the computer 102 in FIG. 1. Similarly, in an embodiment of the disclosure, the set of entities 204 are exemplary embodiments of the EUD 106 of FIG. 1.

The computer system 202 includes suitable logic, circuitry, and/or interfaces for controlling transmission of data within a multi-tenant security environment. The computer system 202 is configured to receive the set of resolution requests 212 from the set of entities 204 associated with the set of tenants 230 of the multi-tenant security environment 208. The set of entities 204 includes at least the first entity 204A associated with the first tenant 230A of the set of tenants 230 and the second entity 204B associated with the second tenant 230B of the set of tenants 230. The computer system 202 is configured to obtain the resolution report data 214. The resolution report data 214 includes the at least the set of natural language texts associated with the set of resolutions 216 for each resolution request of the set of resolution requests 212 and the set of identifiers 218 for each entity of the set of entities 204. The resolution report data 214 is obtained based on the reception of the set of resolution requests 212 from the set of entities 204. The computer system 202 is configured to modify the resolution report data 214 to the structured resolution report data 220. The structured resolution report data 220 includes the first set of structured fields 222 corresponding to the set of natural language texts associated with the set of resolutions 216. The computer system 202 is configured to modify the resolution report data 214 to the structured entity data 224. The structured entity data includes the second set of structured fields 226 corresponding to the set of natural language texts associated with the set of identifiers 218. The computer system 202 is configured to apply the set of transmission policies 228 on at least one of the structured resolution report data 220 or the structured entity data 224. The set of transmission policies 228 is associated with the transmission of the set of resolutions 216 to the set of entities 204. The computer system 202 is configured to detect a transmission of the first set of resolutions 216A of the set of resolutions 216 to the second entity 204B. The transmission of the first set of resolutions 216A is detected based on the application of the set of transmission policies 228 on the at least one of the structured resolution report data 220 or the structured entity data 224. The first set of resolutions 216A is associated with the first entity 204A. The computer system 202 is configured to control a transmission of the first set of resolutions 216A to the first entity 204A. The transmission of the first set of resolutions 216A is controlled based on the detection of the transmission of the first set of resolutions 216A to the second entity 204B.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. For example, embodiment of the disclosure, the computer system 202 may be embodied as a cloud-based service, a cloud-based application, a cloud-based platform, a remote server-based service, a remote server-based application, a remote server-based platform, or a virtual computing system.

Each entity of the set of entities 204 may include suitable logic, circuitry, interfaces, and/or code that are configured to transmit a corresponding resolution request of the set of resolution requests 212 to the computer system 202. In an embodiment of the disclosure, each entity of the set of entities 204 is configured to display the corresponding resolution request of the set of resolution requests 212 on a display screen. Examples of the set of entities 204 may include, but are not limited to, computing devices, mainframe machines, servers, computer work-stations, smartphones, cellular phones, mobile phones, gaming devices, consumer electronic (CE) devices, head-mounted devices, Virtual Reality (VR) Headsets, Augmented Reality (AR) Devices, Mixed Reality (MR) Devices, Projection-based Systems, and/or any device with computer vision display capabilities.

The display screen may include suitable logic, circuitry, and interfaces that are configured to render the corresponding resolution request of the set of resolution requests 212. The display screen may be a touch screen which may enable each tenant of the set of tenants 230 to provide the corresponding resolution request of the set of resolution request 212. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electro-chromic display, or a transparent display. In some embodiments of the disclosure, the display screen may be realized through several known technologies such as, but are not limited to, at least one of a Liquid Crystal Display (LCD) display, a Light Emitting Diode (LED) display, a plasma display, or an Organic LED (OLED) display technology, or any display devices.

Each database of the first set of databases 206 may correspond to an organized collection of data that may be stored and accessed electronically from a computer system (such as the computer system 202). In an embodiment, each database of the first set of databases 206 may be designed to manage, store, retrieve, and update the set of transmission policies 228, the set of resolution requests 212, or a combination thereof. The structure of each database of the first set of databases 206 typically involves tables, records, and fields that can be managed through various database management systems (DBMS). Examples of each database of the first set of databases 206 may include, but are not limited to, a relational database, a Non-Structured Query Language (SQL) database, a hierarchical database, a network database, a transactional database, a data warehouse, and a distributed database.

The multi-tenant security environment 208 includes suitable logic, circuitry, and/or interfaces for the execution of one or more security operations on data associated with the set of entities 204. In an example, the first tenant 230A and the second tenant 230B correspond to a first business and a second business, respectively. The computer system 202 is configured to execute the one or more security operations on first business data (such as a first set of business records) of the first business within the multi-tenant security environment 208. The computer system 202 is configured to execute the one or more security operations on second business data (such as a second set of business records) of the second business within the multi-tenant security environment 208.

The one or more security operations include, but are not limited to, a data monitoring operation, an anomaly detection operation, a resolution determination operation, a data transmission operation, and the like. Specifically, the computer system 202 is configured to execute the one or more operations on the data based on the reception of the set of resolution requests 212 from the set of entities 204. In the data monitoring operation, the computer system 202 is configured to obtain entity performance data for each entity of the set of entities 204. The obtained entity performance data includes the set of identifiers 218 for each entity of the set of entities 204, a processing time associated with each entity of the set of entities 204, an amount of memory usage associated with each entity of the set of entities 204, or a bandwidth associated with each entity of the set of entities 204. In the anomaly detection operation, the computer system 202 is configured to determine an occurrence of a set of anomalies within each entity of the set of entities 204 based on the obtained entity performance data for each entity of the set of entities 204.

In the resolution determination operation, the computer system 202 is configured to determine the resolution report data 214 based on an application of the set of machine learning models 210 on the set of anomalies and the obtained entity performance data. In the data transmission operation, the computer system 202 is configured to transmit the resolution report data 214 to the set of entities 204.

Each machine learning model of the set of machine learning models 210 may be a sophisticated piece of software that leverages natural language processing (NLP) and machine learning to understand, generate, and manipulate human language. Each machine learning model of the set of machine learning models 210 may correspond to a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage the machine learning, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

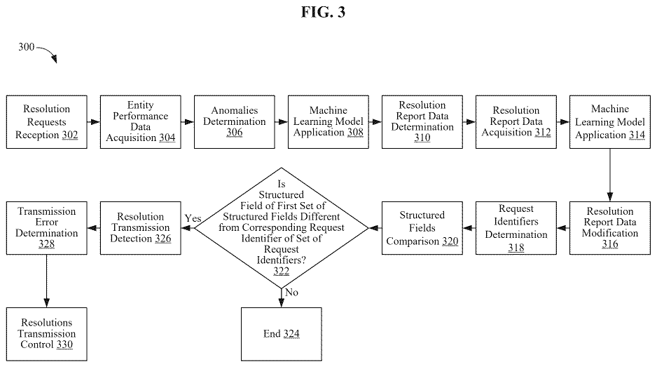

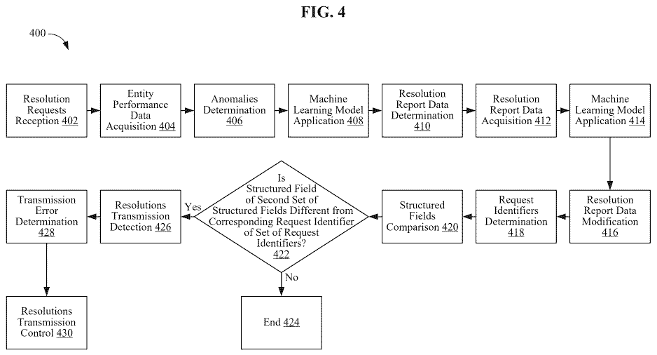

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications. For example, each LLM is pre-trained on a historical set of resolution requests associated with the set of entities 204 and a historical set of resolutions for the historical set of resolution requests. In an example, the first machine learning model 210A of the set of machine learning models 210 is trained to modify the resolution report data 214 to the structured resolution report data 220. In an additional example, the second machine learning model 210B of the set of machine learning models 210 is trained to modify the resolution report data 214 to the structured entity data 224. Details about the modification of the resolution report data 214 based on the application of the set of machine learning models 210 are provided, for example, in FIG. 3 and FIG. 4.

In operation, the computer system 202 is configured to receive the set of resolution requests 212 from the set of entities 204 associated with the set of tenants 230 of the multi-tenant security environment 208. The set of entities 204 includes the first entity 204A associated with the first tenant 230A of the set of tenants 230 and the second entity 204B associated with the second tenant 230B of the set of tenants 230. In an example, the first entity 204A and the second entity 204B correspond to a first user device and a second user device, respectively.

Each resolution request of the set of resolution requests 212 is indicative of an occurrence of a set of anomalies (such as cyber-attacks, hardware failures, and the like) within the corresponding entity of the set of entities 204. In an example, the computer system 202 is configured to receive the first resolution request 212A and the second resolution request 212B from the first entity 204A and the second entity 204B, respectively. In an example, the first resolution request 212A includes the first set of request identifiers for the first entity 204A. The first set of request identifiers includes the first set of identifiers 218A (a name of the first entity 204A, an IP address of the first entity 204A, and the like), timestamps (such as 1 Jan. 2025, 10:10:00) associated with the occurrence of a first set of anomalies of the set of anomalies within the first entity 204A, an identifier associated with a type (such as a XYZ offense) associated with the first set of anomalies, and the like. Similarly, the second resolution request 212B includes a second set of request identifiers for the second entity 204B. Details about the reception of the set of resolution requests 212 from the set of entities 204 are provided, for example, in FIG. 3.

The computer system is configured to obtain the resolution report data 214. The resolution report data 214 includes the at least the set of natural language texts associated with the set of resolutions 216 for each resolution request of the set of resolution requests 212 and the set of identifiers 218 for each entity of the set of entities 204. In an embodiment of the disclosure, the computer system 202 is configured to obtain the resolution report data 214 based on the reception of the set of resolution requests 212 from the set of entities 204. In an example, the computer system 202 is configured to obtain the resolution report data 214 as an output from the set of machine learning models 210. In an additional example, the computer system 202 is configured to obtain the resolution report data 214 as an input from the user 232 (such as a technician, a security expert, and the like) associated with the multi-tenant security environment 208.

In an example, the resolution report data 214 includes a first set of natural language texts of the set of natural language texts. The first set of natural language texts is associated with the first set of resolutions 216A of the set of resolutions 216 for the first resolution request 212A. Further, the first set of natural language texts is associated with the first set of identifiers 218A for the first entity 204A. The first set of natural language texts corresponds to
“This ticket was created for a XYZ offense, where ThreatName:
PUP-XAC-DM—malware issue was identified on Feb. 12, 2017 on machine W7PKU15038L for client Resilient Systems.
We have instructed ABC-END_USER_PROTECTION_EMEA_ISMA_L2—ABC remedy support to update to the latest MNODAT/Definition and On-demand scan.
ABC remedy support team performed the steps but failed to attach the artifacts.
We have reviewed MNO_EPO logs for the past 7 days and found that the virus has been cleaned from the affected host.
The system is clean. Hence, we are closing this incident. We have attached a XYZ screenshot in the Resilient incident attachments”.

In an additional example, the resolution report data 214 includes a second set of natural language texts of the set of natural language texts. The second set of natural language texts is associated with the second set of resolutions 216B of the set of resolutions 216 for the second resolution request 212B. Further, the second set of natural language texts is associated with the second set of identifiers 218B of the set of identifiers 218 for the second entity 204B. The second set of natural language texts corresponds to
“This ticket was created for a XYZ offense, where ThreatName:
PUP-XAC-DM—malware issue was identified on Feb. 12, 2017 on machine W7RU77185L for client Resilient Systems.
We have instructed ABC-END_USER_PROTECTION_EMEA_ISMA_L2-ABC remedy support to update to the latest MNODAT/Definition and On-demand scan.
ABC remedy support team performed the steps but failed to attach the artifacts.
We have reviewed MNO_EPO logs for the past 7 days and found that the virus has been cleaned from the affected host.
The system is clean. Hence, we are closing this incident. We have attached a XYZ screenshot in the Resilient incident attachments”. Details about the acquisition of the resolution report data 214 are provided, for example, in FIG. 3.

The computer system is configured to modify the resolution report data 214 to the structured resolution report data 220. The structured resolution report data 220 includes the first set of structured fields 222 corresponding to the set of natural language texts associated with the set of resolutions 216. In an embodiment of the disclosure, the computer system 202 is configured to apply the set of machine learning models 210 on the resolution report data 214 and the obtained entity performance data. Further, the computer system is configured to modify the resolution report data 214 to the structured resolution report data 220 based on the application of the set of machine learning models 210 on the resolution report data 214 and the obtained entity performance data.

In an example, the structured resolution report data 220 includes the first set of structured fields 222 for the first entity 204A corresponding to the first set of natural language texts associated with the first set of resolutions 216A. The first set of structured fields 222 for the first entity 204A corresponds to:

“
{“Identifier”: “PUP-XAC-DM”,
“Identifier”: “RID#001”,
“Timestamps”: “02/12/2017 10:10:00”,
“Identifier”: “USER#001”,
“Resolution Note”:
“We have instructed ABC-END_USER_PROTECTION_EMEA_ISMA_L2 - ABC remedy
support to update to the latest MNODAT/Definition and On-demand scan.
ABC remedy support team performed the steps but failed to attach the artifacts.
We have reviewed MNO_EPO logs for the past 7 days and found that the virus has been cleaned
from the affected host.
The system is clean. Hence, we are closing this incident. We have attached a XYZ screenshot in
the Resilient incident attachments”.
}
”

In an additional example, the structured resolution report data 220 includes a first set of structured fields for the second entity 204B corresponding to the second set of natural language texts associated with the second set of resolutions 216B. The first set of structured fields for the second entity 204B corresponds to:

“
{“Identifier”: “PUP-XAC-DM”,
“Identifier”: “RID#002”,
“Timestamps”: “02/12/2017 10:30:00”,
“Identifier”: “USER#001”,
“Resolution Note”:
We have instructed ABC-END_USER_PROTECTION_EMEA_ISMA_L2 - ABC remedy
support to update to the latest MNODAT/Definition and On-demand scan.
ABC remedy support team performed the steps but failed to attach the artifacts.
We have reviewed MNO_EPO logs for the past 7 days and found that the virus has been cleaned
from the affected host.
The system is clean. Hence, we are closing this incident. We have attached a XYZ screenshot in
the Resilient incident attachments”.
}

Details about the modification of the resolution report data 214 to the structured resolution report data 220 are provided, for example, in FIG. 3.

The computer system is configured to modify the resolution report data 214 to the structured entity data 224. The structured entity data 224 includes the second set of structured fields 226 corresponding to the set of natural language texts associated with the set of identifiers 218. The structured entity data 224 is modified based on the resolution report data. In an embodiment of the disclosure, the computer system is configured to apply the set of machine learning models 210 on the resolution report data 214 and the obtained entity performance data. Further, the computer system 202 is configured to modify the resolution report data 214 to the structured entity data 224 based on the application of the set of machine learning models 210 on the resolution report data 214 and the obtained entity performance data.

In an example, the structured entity data 224 includes a second set of structured fields for the first entity 204A corresponding to the first set of natural language texts associated with the first set of identifiers 218A. The second set of structured fields for the first entity 204A corresponds to:

“
{“MachineName”: “W7PK15038L”,
“EventType”: “EPO_Malware”,
“AffectedIPAddress”: “10.235.146.179”,
“Location”: “Pakistan”,
“User”: {
“USERID”: “SESA409342”,
“Username”: “ABDUL RASHEED KHAN”
}
}
”

In an additional example, the structured entity data 224 includes a second set of structured fields for the second entity 204B corresponding to the second set of natural language texts associated with the second set of identifiers 218B. The second set of structured fields for the second entity 204B corresponds to:

“
{“MachineName”: “W7RU77185L”,
“EventType”: “XYZOffence”,
“Client”: {
“Name: “Resilient Systems”,
},
“AffectedIPAddress”: “Not Available (N/A)”,
“Location”: “N/A”,
“User”: “N/A”
}
}”

The modification of the resolution report data 214 to the structured resolution report data 220 and the structured entity data 224 allows the computer system 202 to apply the set of transmission policies 228 on the at least one of the structured resolution report data 220 or the structured entity data 224. The set of transmission policies 228 is associated with the transmission of the set of resolutions 216 to the set of entities 204. The modification of the resolution report data 214 allows the computer system 202 to mitigate challenges associated with the manual processing of the large volume of data (such as the resolution report data 214) for the transmission of the set of resolutions 216 to the set of entities 204. Specifically, the modification of the resolution report data 214 allows the computer system 202 to process the resolution report data 214 that includes the set of natural languages for the determination of an association between the set of resolutions 216 and the set of entities 204. Specifically, the modification of the resolution report data 214 allows the computer system 202 to process the resolution report data 214 based on the first set of structured fields 222 and the second set of structured fields 226, thereby mitigating the challenges associated with the variability of the structure of the set of natural language texts within the resolution report data 214. Details about the modification of the resolution report data 214 to the structured entity data 224 are provided, for example, in FIG. 3.

The computer system 202 is configured to apply the set of transmission policies 228 on the at least one of the structured resolution report data 220 or the structured entity data 224. The set of transmission policies 228 is associated with the transmission of the set of resolutions 216 to the set of entities 204. In an embodiment of the disclosure, the application of the set of transmission policies 228 on the structured resolution report data 220 includes a comparison of the first set of structured fields 222 with the set of request identifiers. Specifically, the computer system 202 is configured to determine a set of request identifiers from the second resolution request 212B of the set of resolution requests 212. The second resolution request 212B is associated with the second entity 204B. In an embodiment of the disclosure, the computer system 202 is configured to determine the set of request identifiers from the second resolution request 212B based on the transmission of the first set of resolutions 216A to the second entity 204B. The computer system 202 is configured to compare a structured field of the first set of structured fields 222 with a corresponding request identifier of the set of request identifiers. The structured field of the first set of structured fields 222 is associated with the first entity 204A.

In an example, the structured field of the first set of structured fields 222 corresponds to an identifier (RID #001) associated with the first resolution request 212A of the first entity 204A. The corresponding request identifier corresponds to an identifier (RID #002) associated with the second resolution request 212B of the second entity 204B. The computer system 202 is configured to determine that the structured field (RID #001) of the first set of structured fields 222 is different from the corresponding request identifier (RID #002) of the set of request identifiers based on the comparison of the structured field (RID #001) of the first set of structured fields 222 with the corresponding request identifier (RID #002) of the set of request identifiers.

In an embodiment of the disclosure, the application of the set of transmission policies 228 on the structured entity data 224 includes a comparison of the second set of structured fields 226 with the set of request identifiers. Specifically, the computer system 202 is configured to compare a structured field of the second set of structured fields 226 with the corresponding request identifier of the set of request identifiers. The structured field of the second set of structured fields 226 is associated with the first entity 204A.

In an example, the structured field of the second set of structured fields 226 corresponds to an identifier (W7PK15038L) of the first entity 204A. The corresponding request identifier corresponds to an identifier (W7RU77185L) of the second entity 204B. The computer system 202 is configured to determine that the structured field (W7PK15038L) of the second set of structured fields 226 is different from the corresponding request identifier (W7PKU77185L) of the set of request identifiers based on the comparison of the structured field (W7PKI5038L) of the second set of structured fields 226 with the corresponding request identifier (W7RU77185L) of the set of request identifiers. The application of the set of transmission policies 228 allows the computer system 202 to decrease the likelihood of human errors (such as the provision of the incorrect identifier) for the transmission of the set of resolutions 216. Moreover, the application of the set of transmission policies 228 allows the computer system 202 to detect the incorrect transmission of the set of resolutions 216 to the set of entities 204, thereby ensuring compliance with regulations associated with the transmission of the resolution report data 214. Details about the application of the set of transmission policies 228 on the at least one of the structured resolution report data 220 and the structured entity data 224 are provided, for example, in FIG. 3.

The computer system 202 is configured to detect the transmission of the first set of resolutions 216A of the set of resolutions 216 to the second entity 204B. In an embodiment of the disclosure, the computer system 202 is configured to detect the transmission of the first set of resolutions 216A to the second entity 204B based on the application of the set of transmission policies 228 on the at least one of the structured resolution report data 220 or the structured entity data 224. In an example, the computer system 202 is configured to detect the transmission of the first set of resolutions 216A to the second entity 204B based on the determination that the structured field (RID #001) of the first set of structured fields 222 is different from the corresponding request identifier (RID #002) of the set of request identifiers. In an additional example, the computer system 202 is configured to detect the transmission of the first set of resolutions 216A to the second entity 204B based on the determination that the structured field (W7PK15038L) of the second set of structured fields 226 is different from the corresponding request identifier (W7RU77185L) of the set of request identifiers.

In an example, the first entity 204A and the second entity 204B are associated with a cyber attack and a hardware failure, respectively. The first set of resolutions 216A and the second set of resolutions 216B are associated with a data backup operation and a hardware replacement recommendation, respectively. The computer system 202 is configured to detect the transmission of the first set of resolutions 216A associated with the data backup operation to the second entity 204B. In an additional example, the first entity 204A and the second entity 204B are associated with a transaction team department and a loan team department, respectively. The first set of resolutions 216A and the second set of resolutions 216B are associated with a malicious transaction and a loan query, respectively. The computer system 202 is configured to detect the transmission of the first set of resolutions 216A associated with the malicious transaction to the loan team department. Details about the detection of the transmission of the first set of resolutions 216A to the second entity 204B are provided, for example, in FIG. 3.

The computer system 202 is configured to control the transmission of the first set of resolutions 216A to the first entity 204A. The transmission of the first set of resolutions 216A is controlled based on the detection of the transmission of the first set of resolutions 216A to the second entity 204B. In an embodiment of the disclosure, the computer system 202 is configured to halt the transmission of the first set of resolutions 216A to the second entity 204B based on the detection of the transmission of the first set of resolutions 216A to the second entity 204B. The computer system 202 is further configured to re-transmit the first set of resolutions 216A to the first entity 204A. The controlling of the transmission of the first set of resolutions 216A to the first entity 204A allows the computer system 202 to ensure compliance with regulations associated with the transmission of the resolution report data 214. Details about the controlling of the transmission of the first set of resolutions 216A to the first entity 204A are provided, for example, in FIG. 3. In various embodiments of the disclosure, the computer system 202 is configured to detect an occurrence of a transmission error associated with the transmission of the first set of resolutions 216A to the first entity 204A based on the detection of the transmission of the first set of resolutions 216A to the second entity 204B. Details about the determination of the transmission error are provided, for example, in FIG. 3. The computer system 202 is configured to control the transmission of the first set of resolutions 216A to the first entity 204A based on the determination of the occurrence of the transmission error.

FIG. 3 is a diagram that illustrates exemplary operations for controlling transmission of data within a multi-tenant security environment, in accordance with an embodiment of the disclosure. FIG. 3 is explained in conjunction with elements from FIG. 1, and FIG. 2. With reference to FIG. 3 there is shown a block diagram 300 that illustrates exemplary operations from 302 to 330, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, resolution requests reception operation is executed. In the resolution requests reception operation, the computer system 202 is configured to receive the set of resolution requests 212 from the set of entities 204 associated with the set of tenants 230 of the multi-tenant security environment 208. Specifically, each resolution request of the set of resolution requests 212 is associated with the corresponding entity of the set of entities 204. In an example, the set of resolution requests 212 includes the first resolution request 212A associated with the first entity 204A, the second resolution request 212B associated with the second entity 204B, upto the Nth resolution request 212N associated with the Nth entity 204N.

The set of resolution requests 212 includes the set of request identifiers associated with the corresponding resolution of the set of resolution requests 212. The set of request identifiers includes a set of identifiers associated with each resolution request of the set of resolution requests 212, the set of identifiers 218 associated with each entity of the set of entities 204, and a set of identifiers associated with the set of anomalies that occurred within the set of entities 204. The set of request identifiers is provided in Table 1 below:

TABLE 1
Set of Request Identifiers

| | | | |
|---|---|---|---|
| | Identifiers | | |
| | of | | |
| S. | Resolution | Identifiers of | Identifiers of |
| No. | Request | Anomalies | Entities |

First Entity 204A

| | | | |
|---|---|---|---|
| 1 | 212A | Name: PUP-XAC-DM, | Name: WLPKU15038L |
| | | Timestamps: Feb. 12, 2017 | |
| | | 10:10:00 | |

Second Entity 204B

| | | | |
|---|---|---|---|
| 2 | 212B | Name: PUP-XAC-DM | Name: W7RU77185L |
| | | Timestamps: Feb. 12, 2017 | |
| | | 10:30:00 | |

Referring back to Table 1 at, S. No. (1), the first resolution request 212A includes an identifier (212A) of the first resolution request 212A, the first set of identifiers 218A of the first entity 204A, and a set of identifiers associated with the first set of anomalies that occurred within the first entity 204A. The first set of identifiers 218A associated with the first entity 204A includes a name (WLPKU15038L) of the first entity 204A. The set of identifiers associated with the first set of anomalies includes a name (PUP-XAC-DM) of an anomaly of the first set of anomalies and a timestamp (02/12/2017 10:10:00) of the anomaly that occurred within the first entity 204A.

Further, referring back to Table 1, at S. No. (2), the second resolution request 212B includes an identifier (212B) of the second resolution request 212B, the second set of identifiers 218B of the second entity 204B and a set of identifiers associated with the second set of anomalies that occurred within the second entity 204B. The second set of identifiers 218B associated with the second entity 204B includes a name (W7RU77185L) of the second entity 204B. The set of identifiers associated with the second set of anomalies includes a name (PUP-XAC-DM) of an anomaly of the second set of anomalies and a timestamp (02/12/2017 10:30:00) of the anomaly that occurred within the second entity 204B.

In an embodiment of disclosure, the computer system 202 is configured to receive the set of resolution requests 212 from the first set of databases 206. Specifically, the computer system 202 is configured to receive the set of resolution requests 212 based on a set of database queries associated with the first set of databases 206. Examples of the set of database queries include, but are not limited to, structured query language (SQL) queries, Graph QL queries, and non-structured database queries. The computer system 202 is configured to receive the set of resolution requests 212 based on the set of data formats (such as the JSON format, the XML format, and the like). In various embodiments of the disclosure, the computer system 202 is configured to receive the set of resolution requests 212 from a set of data queues associated with at least one of the set of entities 204, the set of anomalies, or a combination thereof. Additionally, the set of entities 204 is configured to transmit the set of resolution requests 212 to the set of data queues. In various embodiments of the disclosure, the computer system 202 is configured to receive the set of resolution requests 212 based on an occurrence of a set of events (such as the cyber attacks, the hardware failures, and the like) within the set of entities 204.

At 304, an entity performance data acquisition operation is executed. In the entity performance data acquisition, the computer system 202 is configured to obtain the entity performance data for each entity of the set of entities 204 based on the reception of the set of resolution requests 212 from the set of entities 204. The obtained entity performance data includes the set of identifiers 218 for each entity of the set of entities 204, the processing time associated with each entity of the set of entities 204, the amount of memory usage associated with each entity of the set of entities 204, or the bandwidth associated with each entity of the set of entities 204. The obtained entity performance data is provided in Table 2 below:

TABLE 2
Entity Performance Data

| | | | | |
|---|---|---|---|---|
| S. | Identifiers | Processing | Memory | |
| No. | of Entities | Time | Usage | Bandwidth |

First Entity 204A

| | | | | |
|---|---|---|---|---|
| 1 | WLPKU15038L | 120 milliseconds | 220 megabytes | 130 |
| | | | | megabytes |
| | | | | per second |

Second Entity 204B

| | | | | |
|---|---|---|---|---|
| 2 | W7RU77185L | 110 milliseconds | 210 megabytes | 160 |
| | | | | megabytes |
| | | | | per second |

Referring back to Table 2, at S. No. (1), the entity performance data includes the first set of identifiers 218A (such as the name (WLPKU15038L)) of the first entity 204A, a first processing time (120 milliseconds) of the first entity 204A, a first amount (220 megabytes) of memory usage by the first entity 204A, a first bandwidth (130 megabytes per second) of the first entity 204A. Further, referring back to Table 2, at S. No. (2), the entity performance data further includes the second set of identifiers 218B (such as the name (W7RU77185L) of the second entity 204B, a second processing time (110 milliseconds) of the second entity 204B, a second amount (210 megabytes) of memory usage by the second entity 204B, and a second bandwidth (160 megabytes per second) of the second entity 204B.

In an embodiment of disclosure, the computer system 202 is configured to obtain the entity performance data from one or more sources associated with the corresponding entity of the set of entities 204. In an example, the one or more sources correspond to a set of logs associated with a performance of the corresponding entity of the set of entities 204. In an embodiment of the disclosure, the computer system 202 is configured to obtain the set of logs from a memory associated with the corresponding entity of the set of entities 204. In an embodiment of the disclosure, the computer system 202 is configured to obtain the set of logs from the first set of databases 206. In an embodiment of the disclosure, the computer system 202 is configured to determine the occurrence of the set of anomalies within the set of entities 204 based on the obtained entity performance data. Details about the determination of the occurrence of the set of anomalies within the set of entities 204 based on the obtained entity performance data are provided below at 306.

At 306, an anomalies determination operation is executed. In the anomalies determination operation, the computer system 202 is configured to determine the occurrence of the set of anomalies within each entity of the set of entities 204 based on the obtained entity performance data.

In an example, the computer system 202 is configured to determine that a first processing time (120 milliseconds) associated with the first entity 204A is greater than a processing time threshold (100 milliseconds). Further, the computer system 202 is configured to determine the occurrence of the set of anomalies within the first entity 204A based on the determination that the first processing time (120 milliseconds) associated with the first entity 204A is greater than the processing time threshold (100 milliseconds). Similarly, the computer system 202 is configured to determine the occurrence of the set of anomalies within each entity of the set of entities 204.

In an additional example, the computer system 202 is configured to determine a performance score (such as 9) based on a first bandwidth (130 megabytes per second) associated with the first entity 204A. Further, the computer system 202 is configured to compare the performance score (9) with a performance score threshold (10). The computer system 202 is configured to determine the occurrence of the set of anomalies within the first entity 204A based on the determination that the performance score (9) is less than the performance score threshold (10). Similarly, the computer system 202 is configured to determine the occurrence of the set of anomalies within each entity of the set of entities 204.

In yet additional example, the computer system 202 is configured to determine a first difference between the first memory usage (220 megabytes) associated with the first entity 204A at a first time period with a historical memory usage (150 megabytes) at a second time period. The computer system 202 is configured to compare the first difference (70) with a difference threshold (20). The computer system 202 is configured to determine the occurrence of the set of anomalies with the first entity 204A based on the determination that the first difference (70) is greater than the difference threshold (20). Similarly, the computer system 202 is configured to determine the occurrence of the set of anomalies within each entity of the set of entities 204.

At 308, a machine learning model application operation is executed. In the machine learning model application operation, the computer system 202 is configured to apply the set of machine learning models 210 on the set of anomalies and the obtained entity performance data. In an embodiment of the disclosure, the computer system 202 is configured to apply the first machine learning model 210A on the set of anomalies and the obtained entity performance data to determine the resolution report data 214. Details about the application of the first machine learning model 210A are provided below at 310.

At 310, a resolution report data determination operation is executed. In the resolution report data determination operation, the computer system 202 is configured to determine the resolution report data 214 based on the application of the set of machine learning models 210 on the set of anomalies and the obtained entity performance data. The resolution report data 214 includes at least the set of natural language texts associated with the set of resolutions 216 for each resolution request of the set of resolution requests 212 and the set of identifiers 218 for each entity of the set of entities 204.

In an example, the resolution report data 214 includes the first set of natural language texts associated with the first set of resolution 216A for the first resolution request 212A and the first set of identifiers for the first entity 204A. The first set of natural language texts corresponds to
“This ticket was created for a XYZ offense, where ThreatName:
PUP-XAC-DM-malware issue was identified on Feb. 12, 2017 on machine WLPKU15038L for client Resilient Systems.
We have instructed ABC-END USER PROTECTION EMEA ISMA_L2—ABC remedy support to update to the latest MNODAT/Definition and On-demand scan.
ABC remedy support team performed the steps but failed to attach the artifacts.
We have reviewed MNO_EPO logs for the past 7 days and found that the virus has been cleaned from the affected host.
The system is clean. Hence, we are closing this incident. We have attached a XYZ screenshot in the Resilient incident attachments”.

In an additional example, the resolution report data 214 includes the second set of natural language texts associated with the second set of resolutions 216B for the second resolution request 212B and the second set of identifiers 218B for the second entity 204B. The second set of natural language texts corresponds to
“This ticket was created for a XYZ offense, where ThreatName:
PUP-XAC-DM-malware issue was identified on Feb. 12, 2017 on machine W7RU77185L for client Resilient Systems.
We have instructed ABC-END_USER_PROTECTION_EMEA_ISMA_L2—ABC remedy support to update to the latest MNODAT/Definition and On-demand scan.
ABC remedy support team performed the steps but failed to attach the artifacts.
We have reviewed MNO_EPO logs for the past 7 days and found that the virus has been cleaned from the affected host.
The system is clean. Hence, we are closing this incident. We have attached a XYZ screenshot in the Resilient incident attachments”.

In an example, the computer system 202 is configured to provide the set of resolution requests 212 and the obtained entity performance data, as an input, to the first machine learning model 210A. The first machine learning model 210A is configured to identify the set of identifiers 218 from the set of resolutions request 212 and the obtained entity performance data. In an example, the first machine learning model 210A is configured to employ an attention mechanism on the set of resolution request 212 and the obtained entity performance data. In the attention mechanism, the first machine learning model 210A is configured to determine entity contextual data within the set of resolution requests 212 and the obtained entity performance data. Specifically, the first machine learning model 210A is configured to determine the entity contextual data from both directions within a sequence associated with the set of resolution request 212 and the obtained entity performance data. The entity contextual data is indicative of an entity type for at least one portion of the sequence associated with the set of resolution requests 212 and the obtained entity performance data. Examples of the entity type include, but are not limited to, a name of at least one entity of the set of entities 204, a location of at least one entity of the set of entities 204, and an identifier associated with at least one anomaly of the set of anomalies.

Further, the first machine learning model 210A is configured to determine the resolution report data 214 based on the determined entity contextual data and a set of resolution rules. Each resolution rule of the set of resolution rules is indicative of a set of operations for the at least one anomaly of the set of anomalies. In an example, the identifier of the at least one anomaly is indicative of an increase of an amount of memory utilized by the at least one entity. The first machine learning model 210A is configured to determine a system restart operation for the at least one entity based on the determination that the at least one anomaly is indicative of the increase of the amount of memory utilized by the at least one entity.

At 312, a resolution report data acquisition operation is executed. In the resolution report data acquisition operation, the computer system 202 is configured to obtain the resolution report data 214 based on the determination of the resolution report data 214. In an embodiment of the disclosure, the computer system 202 is configured to obtain the resolution report data 214, as an output, of the first machine learning model 210A. In an alternate embodiment of the disclosure, the computer system 202 is configured to obtain the resolution report data 214 as an input from the user 232 associated with the multi-tenant security environment 208.

At 314, a machine learning model application operation is executed. In the machine learning model application operation, the computer system 202 is configured to apply the set of machine learning models 210 on the resolution report data 214. In an example, the computer system 202 is configured to apply the second machine learning model 210B on the resolution report data 214. The computer system 202 is configured to apply the second machine learning model 210B to modify the resolution report data 214. Details about the application of the second machine learning model 210B to modify the resolution report data 214 are provided below at 316.

At 316, a resolution report data modification operation is executed. In the resolution report data modification operation, the computer system 202 is configured to modify the resolution report data 214 to the structured resolution report data 220 based on the application of the set of machine learning models 210 on the resolution report data 214. The structured resolution report data 220 includes the first set of structured fields 222 corresponding to the set of natural language texts associated with the set of resolutions 216.

In an example, the second machine learning model 210B is configured to extract resolution intermediate data from the resolution report data 214. The extracted resolution intermediate data includes the identifier of the set of anomalies associated with each entity of the set of entities 204, the identifier of the set of resolutions 216 associated with each entity of the set of entities 204, the timestamp of the occurrence of the set of anomalies associated with each entity of the set of entities 204, or the identifier of the user 232 associated with the set of resolution requests 212. In an example, the second machine learning model 210B is configured to execute a classification operation on the resolution report data 214. The second machine learning model 210B is further configured to extract the intermediate resolution data based on the execution of the classification operation on the resolution report data 214. Specifically, in the classification operation, the second machine learning model 210B is configured to classify at least one portion of the resolution report data 214 to a class of a first set of classes. Each class of the first set of classes is indicative of one of the set of anomalies, the set of resolutions 216, the timestamp of the occurrence of the set of anomalies, or the user 232 associated with the set of resolution requests 212. The computer system 202 is configured to parse the intermediate resolution data to the first set of structured fields 222. The first set of structured fields 222 is associated with a set of data formats. The set of data formats includes, but is not limited to, a javascript object notation (JSON) format or an extensible markup language (XML) format. It may be noted that the second machine learning model 210B may execute additional operations for the extraction of the intermediate resolution data from the resolution report data 214.

The first set of structured fields 222 includes a structured field for an identifier of the set of anomalies associated with each entity of the set of entities 204, a structured field for an identifier of the set of resolutions 216 associated with each entity of the set of entities 204, a structured field for a timestamp of an occurrence of the set of anomalies associated with each entity of the set of entities 204, or a structured field for an identifier of the user 232 associated with the set of resolution requests 212.

In an example, the structured resolution report data 220 includes the first set of structured fields for the first entity 204A corresponding to the first set of natural language texts associated with the first set of resolutions 216A. The first set of structured fields for the first entity 204A corresponds to:

“
{“Identifier”: “PUP-XAC-DM”,
“Identifier”: “RID#001”,
“Timestamps”: “02/12/2017 10:10:00”,
“Identifier”: “USER#001”,
“Resolution Note”:
“We have instructed ABC-END_USER_PROTECTION_EMEA_ISMA_L2 - ABC remedy
support to update to the latest MNODAT/Definition and On-demand scan.
ABC remedy support team performed the steps but failed to attach the artifacts.
We have reviewed MNO_EPO logs for the past 7 days and found that the virus has been cleaned
from the affected host.
The system is clean. Hence, we are closing this incident. We have attached a XYZ screenshot in
the Resilient incident attachments”.
}
”

In an additional example, the structured resolution report data 220 includes the first set of structured fields for the second entity 204B corresponding to the first set of natural language texts associated with the second set of resolutions 216B. The first set of structured fields for the second entity 204B corresponds to:

“
{“Identifier”: “PUP-XAC-DM”,
“Identifier”: “RID#002”,
“Timestamps”: “02/12/2017 10:30:00”,
“Identifier”: “USER#001”,
“Resolution Note”:
We have instructed ABC-END_USER_PROTECTION_EMEA_ISMA_L2 - ABC remedy
support to update to the latest MNODAT/Definition and On-demand scan.
ABC remedy support team performed the steps but failed to attach the artifacts.
We have reviewed MNO_EPO logs for the past 7 days and found that the virus has been cleaned
from the affected host.
The system is clean. Hence, we are closing this incident. We have attached a XYZ screenshot in
the Resilient incident attachments”.
}
”

At 318, a request identifiers determination operation is executed. In the request identifiers determination operation, the computer system 202 is configured to determine the set of request identifiers from the second resolution request 212B of the set of resolution requests 212.

The second resolution request 212B is associated with the second entity 204B. In an embodiment of the disclosure, the computer system 202 is configured to determine the set of request identifiers from the second resolution request 212B based on the transmission of the first set of resolutions 216A to the second entity 204B.

At 320, a structured fields comparison operation is executed. In the structured fields comparison operation, the computer system 202 is configured to compare the structured field of the first set of structured fields 222 with the corresponding request identifier of the set of request identifiers. The structured field of the first set of structured fields 222 is associated with the first entity 204A.

In an example, the structured field of the first set of structured fields 222 corresponds to the timestamp (02/12/2007 10:10:00) associated with the occurrence of the anomaly of the first set of anomalies within the first entity 204A. The corresponding request identifier corresponds to the timestamp (02/12/2007 10:30:00) associated with the occurrence of the anomaly of the second set of anomalies within the second entity 204B.

At 322, a determination is made whether the structured field (02/12/2007 10:10:00) of the first set of structured fields 222 is different from the corresponding request identifier (02/12/2007 10:30:00) of the set of request identifiers or not. In an embodiment of the disclosure, the computer system 202 is configured to determine that the structured field (02/12/2007 10:10:00) of the first set of structured fields 222 is different from the corresponding request identifier (02/12/2007 10:30:00) of the set of request identifiers based on the comparison of the structured field (02/12/2007 10:10:00) of the first set of structured fields 222 with the corresponding request identifier (02/12/2007 10:30:00) of the set of request identifiers. In an embodiment of disclosure, the operations of the method end at 324 based on a determination that the structured field (02/12/2007 10:10:00) of the first set of structured fields 222 is identical to the corresponding request identifier (02/12/2007 10:30:00) of the set of request identifiers. Otherwise, the operations of the method proceed to 326 based on a determination that the structured field (02/12/2007 10:10:00) of the first set of structured fields 222 is different from the corresponding request identifier (02/12/2007 10:30:00) of the set of request identifiers.

At 326, a resolutions transmission detection operation is executed. In the resolutions transmission detection operation, the computer system 202 is configured to detect the transmission of the first set of resolutions 216A of the set of resolutions 216 to the second entity 204B. The first set of resolutions 216A is associated with the first entity 204A. In an embodiment of the disclosure, the computer system 202 is configured to detect the transmission of the first set of resolutions 216A based on the application of the set of transmission policies 228 on the structured resolution report data 220. In an embodiment of the disclosure, the computer system 202 is configured to detect the transmission of the first set of resolutions 216A to the second entity 204B based on the determination that the structured field (02/12/200710:10:00) of the first set of structured fields 222 is different from the corresponding request identifier (02/12/2007 10:30:00) of the set of request identifiers. In various embodiments of the disclosure, the computer system 202 is configured to generate an alert based on the detection of the transmission of the first set of resolutions 216 to the second entity 204B.

At 328, a transmission error determination operation is executed. In the transmission error determination operation, the computer system 202 is configured to determine an occurrence of a transmission error associated with the transmission of the first set of resolutions 216A to the first entity 204A. In an embodiment of the disclosure, the computer system 202 is configured to determine the transmission error based on the detection of the transmission of the first set of resolutions 216A to the second entity 204B.

At 330, a resolutions transmission control operation is executed. In the resolutions transmission control operation, the computer system 202 is configured to control the transmission of the first set of resolutions 216A to the first entity 204A based on the determination of the occurrence of the transmission error. In an embodiment of the disclosure, the computer system 202 is configured to halt the transmission of the first set of resolutions 216A to the second entity 204B based on the determination of the transmission error. The computer system 202 is further configured to transmit the first set of resolutions 216A to the first entity 204A.

In an example, the computer system 202 is configured to transmit a transmission control packet (such as a reset packet) to the second entity 204B. The computer system 202 is configured to halt the transmission of the first set of resolutions 216A to the second entity 204B based on the transmission of the transmission control packet. In an additional example, the computer system 202 is configured to update a route associated with the transmission of the first set of resolutions 216A to the second entity 204B based on an internet control message protocol (ICMP). The computer system 202 is configured to re-route the transmitted first set of resolutions 216A to the computer system 202 based on the updated route. In various embodiments of the disclosure, the computer system 202 is configured to identify the second set of resolutions 216B from the set of resolutions 216 based on the control of the transmission of the first set of resolutions 216A to the first entity 204A. The second set of resolutions 216B is associated with the second entity 204B. The computer system 202 is configured to control the transmission of the second set of resolutions 216B to the second entity 204B based on the identification of the second set of resolutions 216B.

FIG. 4 is a diagram that illustrates second exemplary operations for controlling transmission of data within a multi-tenant security environment, in accordance with an embodiment of the disclosure. FIG. 4 is explained in conjunction with elements from FIG. 1, and FIG. 2. With reference to FIG. 4 there is shown a block diagram 400 that illustrates exemplary operations from 402 to 430, as described herein. The second exemplary operations illustrated in the block diagram 400 may start at 402 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a resolution requests reception operation is executed. In the resolution requests reception operation, the computer system 202 is configured to receive the set of resolution requests 212 from the set of entities 204 associated with the set of tenants 230 of the multi-tenant security environment 208. Details about the reception of the set of resolution requests 212 are provided, for example, in FIG. 3.

At 404, an entity performance data acquisition operation is executed. In the entity performance data acquisition operation, the computer system 202 is configured to obtain the entity performance data for each entity of the set of entities 204 based on the reception of the set of resolution requests 212 from the set of entities 204. Details about the acquisition of the obtained entity performance data are provided, for example, in FIG. 3.

At 406, an anomalies determination operation is executed. In the anomalies determination operation, the computer system 202 is configured to determine the occurrence of the set of anomalies within each entity of the set of entities 204 based on the obtained entity performance data. Details about the determination of the set of anomalies within each entity of the set of entities 204 are provided, for example, in FIG. 3.

At 408, a machine learning model application operation is executed. In the machine learning model application operation, the computer system 202 is configured to apply the set of machine learning models 210 on the set of anomalies and the obtained entity performance data. In an embodiment of the disclosure, the computer system 202 is configured to apply the first machine learning model 210A on the set of anomalies and the obtained entity performance data to determine the resolution report data 214. Details about the application of the first machine learning model 210A on the set of anomalies and the obtained entity performance data are provided, for example, in FIG. 3.

At 410, a resolution report data determination operation is executed. In the resolution report data determination operation, the computer system 202 is configured to determine the resolution report data 214 based on the application of the set of machine learning models 210 on the set of anomalies and the obtained entity performance data. The resolution report data 214 includes at least the set of natural language texts associated with the set of resolutions 216 for each resolution request of the set of resolution requests 212 and the set of identifiers 218 for each entity of the set of entities 204. The resolution report data 214 is obtained based on the reception of the set of resolution requests 212 from the set of entities 204. Details about the determination of the resolution report data 214 are provided, for example, in FIG. 3.

At 412, a resolution report data acquisition operation is executed. In the resolution report data acquisition operation, the computer system 202 is configured to obtain the resolution report data 214 based on the determination of the resolution report data 214. In an embodiment of the disclosure, the computer system 202 is configured to obtain the resolution report data 214, as the output, of the first machine learning model 210A. Details about the acquisition of the resolution report data 214 are provided, for example, in FIG. 3.

At 414, a machine learning model application operation is executed. In the machine learning model application operation, the computer system 202 is configured to apply the set of machine learning models 210 on the resolution report data 214 and the obtained entity performance data. In an example, the computer system 202 is configured to apply the second machine learning model 210B on the resolution report data 214 and the obtained entity performance data. The computer system 202 is configured to apply the second machine learning model 210B to modify the resolution report data 214. Details about the application of the set of machine learning models 210 to modify the resolution report data 214 are provided below at 416.

At 416, a resolution report data modification operation is executed. In the resolution report data modification operation, the computer system 202 is configured to modify the resolution report data 214 to the structured entity data 224 based on the application of the set of machine learning models 210 on the resolution report data 214 and the obtained entity performance data. The structured entity data 224 includes the second set of structured fields 226 corresponding to the set of natural language texts associated with the set of identifiers 218. The second set of structured fields 226 includes a structured field for an identifier of each entity of the set of entities 204, a structured field for an identifier of a respective tenant of each entity of the set of entities 204, or a structured field for an identifier of a location associated with each entity of the set of entities 204.

In an example, the second machine learning model 210B is configured to extract entity intermediate data from the resolution report data 214 and the obtained entity performance data. The extracted entity intermediate data includes the identifier of each entity of the set of entities 204, the identifier of the respective tenant of each entity of the set of entities 204, or the identifier of the location associated with each entity of the set of entities 204. In an example, the second machine learning model 210B is configured to execute a classification operation on the resolution report data 214 and the obtained entity performance data. The second machine learning model 210B is further configured to extract the intermediate entity data based on the execution of the classification operation on the resolution report data 214 and the obtained entity performance data. Specifically, in the classification operation, the second machine learning model 210B is configured to classify at least one portion of the resolution report data 214 or the obtained entity performance data to a class of a second set of classes. Each class of the second set of classes is indicative of one of the set of entities 204, the set of tenants 230, or a location associated with the set of entities 204. The computer system 202 is configured to parse the intermediate entity data to the second set of structured fields 226. The second set of structured fields 226 is associated with the set of data formats. The set of data formats includes, but is not limited to, the JSON format or the XML format. It may be noted that the second machine learning model 210B may execute additional operations for the extraction of the intermediate entity data from the resolution report data 214 and the obtained entity performance data.

In an example, the structured entity data 224 includes the second set of structured fields for the first entity 204A corresponding to the first set of natural language texts associated with the first set of identifiers. The second set of structured fields for the first entity 204A corresponds to:

“
{“MachineName”: “W7PK15038L”,
“EventType”: “EPO_Malware”,
“AffectedIPAddress”: “10.235.146.179”,
“Location”: “Pakistan”,
“User”: {
“USERID”: “SESA409342”,
“Username”: “ABDUL RASHEED KHAN”
}
}

In an additional example, the structured entity data 224 includes the second set of structured fields for the second entity 204B corresponding to the second set of natural language texts associated with the second set of identifiers 218B. The second set of structured fields for the second entity 204B corresponds to:

“
{“MachineName”: “W7RU77185L”,
“EventType”: “XYZOffence”,
“Client”: {
“Name: “Resilient Systems”,
},
“AffectedIPAddress”: “N/A”,
“Location”: “N/A”,
“User”: “N/A”
}
}

At 418, a request identifiers determination operation is executed. In the request identifiers determination operation, the computer system 202 is configured to determine the set of request identifiers from the second resolution request 212B of the set of resolution requests 212. The second resolution request 212B is associated with the second entity 204B. The set of request identifiers is determined based on the transmission of the first set of resolutions 216A to the second entity 204B. Details about the determination of the set of request identifiers are provided, for example, in FIG. 3.

At 420, a structured fields comparison operation is executed. In the structured fields comparison operation, the computer system 202 is configured to compare the structured field of the second set of structured fields 226 with the corresponding request identifier of the set of request identifiers. The structured field of the second set of structured fields 226 is associated with the first entity 204A. In an example, the structured field of the second set of structured fields 226 corresponds to the IP address (10.235.146.179) of the first entity 204A. The corresponding request identifier of the set of request identifiers corresponds to the IP address (N/A) of the second entity 204B.

At 422, a determination is made whether the structured field of the second set of structured fields 226 is different from the corresponding request identifiers of the set of request identifiers or not. In an embodiment of the disclosure, the computer system 202 is configured to determine that the structured field of the second set of structured fields 226 is different from the corresponding request identifier of the set of request identifiers based on the comparison of the structured field of the second set of structured fields 226 with the corresponding request identifier of the set of request identifiers. In an embodiment of disclosure, the operations of the method end at 424 based on a determination that the structured field (10.235.146.179) of the second set of structured fields 226 is identical to the corresponding request identifier (10.235.146.179) of the set of request identifiers. Otherwise, the operations of the method proceed to 426 based on a determination that the structured field (10.235.146.179) of the second set of structured fields 226 is different from the corresponding request identifier (N/A) of the set of request identifiers.

At 426, a resolutions transmission detection operation is executed. In the resolutions transmission detection operation, the computer system 202 is configured to detect the transmission of the first set of resolutions 216A of the set of resolutions 216 to the second entity 204B of the set of entities 204. The first set of resolutions 216A is associated with the first entity 204A of the set of entities 204. In an embodiment of the disclosure, the computer system 202 is configured to detect the transmission of the first set of resolutions 216A based on the application of the set of transmission policies 228 on the structured entity data 224. In an embodiment of the disclosure, the computer system 202 is configured to detect the transmission of the first set of resolutions 216A to the second entity 204B based on the determination that the structured field (10.235.146.179) of the second set of structured fields 226 is different from the corresponding request identifier (N/A) of the set of request identifiers.

At 428, a transmission error determination operation is executed. In the transmission error determination operation, the computer system 202 is configured to determine the occurrence of the transmission error associated with the transmission of the first set of resolutions 216A to the first entity 204A. In an embodiment of the disclosure, the computer system 202 is configured to determine the transmission error based on the detection of the transmission of the first set of resolutions 216A to the second entity 204B. Details about the determination of the transmission error are provided, for example, in FIG. 3.

At 430, a resolutions transmission control operation is executed. In the resolutions transmission control operation, the computer system 202 is configured to control the transmission of the first set of resolutions 216A to the first entity 204A based on the detection of the transmission of the first set of resolutions 216A to the second entity 204B. Specifically, the computer system 202 is configured to control the transmission of the first set of resolutions 216A to the first entity 204A based on the determination of the transmission error. Details about the control of the transmission of the first set of resolutions 216A to the first entity 204A are provided, for example, in FIG. 3.

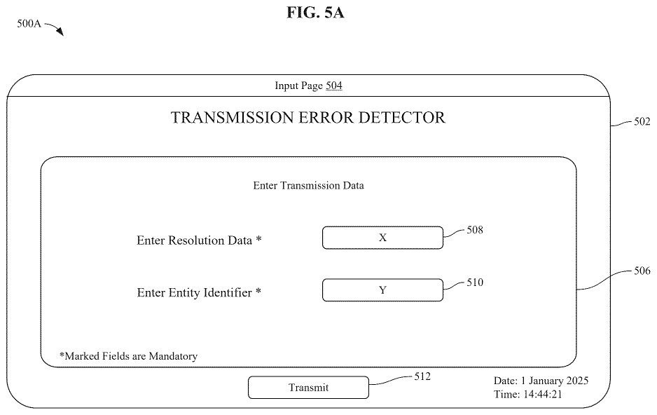

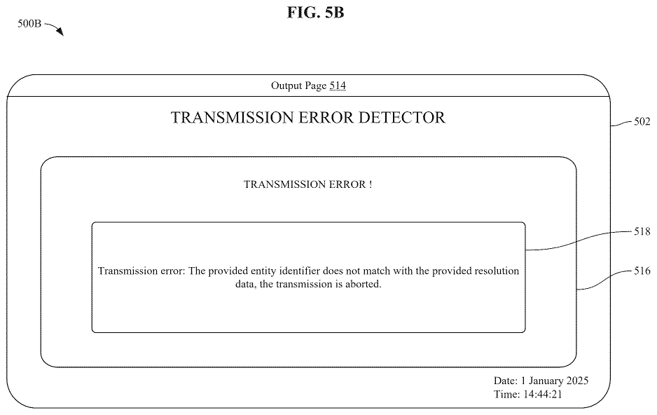

FIG. 5A is a diagram that illustrates an exemplary first user interface for transmission of data, in accordance with an embodiment of the disclosure. FIG. 5A is explained in conjunction with elements from FIG. 1, FIG. 2, FIG. 3, and FIG. 4. With reference to FIG. 5A, there is shown an exemplary diagram 500A that includes a user device 502 and an exemplary first input page 504. The exemplary first input page 504 includes a first user interface (UI) element 506, a second UI element 508, a third UI element 510, and a fourth UI element 512. The user device 502 is an example embodiment of the set of entities 204 of FIG. 2.

With reference to FIG. 5A, the computer system 202 is configured to receive one or more inputs from the user device 502. The user device 502 includes a display screen that renders the exemplary first input page 504 on the user device 502 to be seen by the user 232. In an embodiment, the exemplary first input page 504 corresponds to a web page or an online form that is designed to collect information from the user 232 who wishes to transmit the resolution report data 214. In an embodiment of the disclosure, the exemplary first input page 504 is used to gather relevant data from the user 232 to transmit the resolution report data 214.

The first UI element 506 corresponds to a textbox that includes a message for the user 232, for example, “Enter Transmission Data”. The first UI element 506 further includes the second UI element 508 and the third UI element 510.

The second UI element 508 corresponds to a textbox labeled “Enter Resolution Data”. In an embodiment of the disclosure, the second UI element 508 is configured to obtain the resolution report data 214. In an example, the second UI element 508 is configured to obtain the first set of resolutions 216A for the first entity 204A.

The third UI element 510 corresponds to a textbox labeled “Enter Entity Identifier”. In an embodiment of the disclosure, the third UI element 510 is configured to receive the set of identifiers 218 for the transmission of the resolution report data 214. In an example, the third UI element 510 is configured to receive the set of identifiers 218 for the transmission of the first set of resolutions 216A to the first entity 204A.

The fourth UI element 512 corresponds to a button and is labeled as “Transmit”. Upon selection of the fourth UI element 512, the computer system 202 is configured to render an exemplary output page 514 displayed in FIG. 5B.

FIG. 5B is a diagram that illustrates an exemplary second user interface for controlling transmission of data within a multi-tenant environment, in accordance with an embodiment of the disclosure. FIG. 5B is explained in conjunction with elements from FIG. 1, FIG. 2, FIG. 3, FIG. 4, and FIG. 5A. With reference to FIG. 5B, there is shown an exemplary diagram 500B that includes the user device 502 and the exemplary output page 514. The exemplary output page 514 includes a fifth UI element 516 that includes a sixth UI element 518.

With reference to FIG. 5B, the computer system 202 is configured to render the exemplary output page 514 on the exemplary second UI. The user device 502 includes the display screen that renders the exemplary output page 514 to the user 232.

The computer system 202 is configured to render the exemplary output page 514 on the exemplary second UI of the user device 502. The exemplary output page 514 corresponds to a web page or online form that is designed to render the transmission error associated with the transmission of the first set of resolutions 216A to the first entity 204A.

The fifth UI element 516 corresponds to a textbox that includes a message for the user 232, for example, “TRANSMISSION ERROR!”. The fifth UI element 516 further includes the sixth UI element 518. The sixth UI element 518 corresponds to a textbox labeled “Transmission error: The provided entity identifier does not match with the provided resolution data, the transmission is aborted”. The sixth UI element 518 is configured to halt the transmission of the first set of resolutions 216A to the second entity 204B.

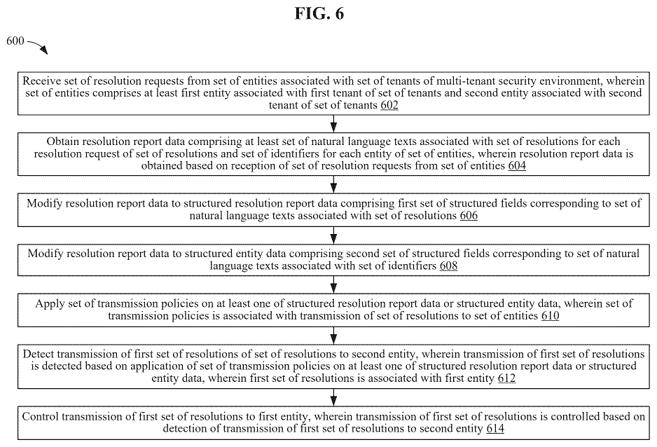

FIG. 6 is a diagram that illustrates a first flowchart 600 of a method for controlling transmission of data within a multi-tenant security environment, in accordance with an embodiment of the disclosure. FIG. 6 is explained in conjunction with elements from FIG. 1, FIG. 2, FIG. 3, FIG. 4, FIG. 5A, and FIG. 5B. The operations of the method depicted by the first flowchart 600 may be executed by any computing system, for example, by the computer 102 of FIG. 1 or the computer system 202 of FIG. 2.

At 602, the set of resolution requests 212 is received from the set of entities 204 associated with the set of tenants 230 of the multi-tenant security environment 208. The set of tenants 230 includes at least the first entity 204A associated with the first tenant 230A of the set of tenants 230 and the second entity 204B associated with the second tenant 230B of the set of tenants 230. In an embodiment of the disclosure, the computer system 202 is configured to receive the set of resolution requests 212 from the set of entities 204 associated with the set of tenants 230 of the multi-tenant security environment 208. Details about the reception of the set of resolution request 212 are provided, for example, in FIG. 3 and FIG. 4.

At 604, the resolution report data 214 is obtained. The resolution report data 214 includes at least the set of natural language texts associated with the set of resolutions 216 for each resolution request of the set of resolution requests 212 and the set of identifiers 218 for each entity of the set of entities 204. The resolution report data 214 is obtained based on the reception of the set of resolution requests 212 from the set of entities 204. In an embodiment of the disclosure, the computer system 202 is configured to obtain the resolution report data 214. Details about the acquisition of the resolution report data 214 are provided, for example, in FIG. 3 and FIG. 4.

At 606, the resolution report data 214 is modified to the structured resolution report data 220. The structured resolution report data includes the first set of structured fields 222 corresponding to the set of natural language texts associated with the set of resolutions 216. In an embodiment of the disclosure, the computer system 202 is configured to modify the resolution report data 214 to the structured resolution report data 220. Details about the modification of the resolution report data 214 to the structured resolution report data 220 are provided, for example, in FIG. 3 and FIG. 4.

At 608, the resolution report data 214 is modified to the structured entity data 224. The structured entity data 224 includes the second set of structured fields 226 corresponding to the set of natural language texts associated with the set of identifiers 218. In an embodiment of the disclosure, the computer system 202 is configured to modify the resolution report data 214 to the structured entity data 224. Details about the modification of the resolution report data 214 to the structured entity data 224 are provided, for example, in FIG. 3 and FIG. 4.

At 610, the set of transmission policies 228 is applied on the at least one of the structured resolution report data 220 or the structured entity data 224. The set of transmission policies 228 is associated with the transmission of the set of resolutions 216 to the set of entities 204. In an embodiment of the disclosure, the computer system 202 is configured to apply the set of transmission policies 228 on the at least one of the structured resolution report data 220 or the structured entity data 224. Details about the application of the set of transmission policies 228 on the at least one of the structured resolution report data 220 or the structured entity data 224 are provided, for example, in FIG. 3 and FIG. 4.

At 612, the transmission of the first set of resolutions 216A of the set of resolutions 216 to the second entity 204B is detected. The transmission of the first set of resolutions 216A is detected based on the application of the set of transmission policies 228 on at least one of the structured resolution report data 220 or the structured entity data 224. The first set of resolutions 216A is associated with the first entity 204A. In an embodiment of the disclosure, the computer system 202 is configured to detect the transmission of the first set of resolutions 216A of the set of resolutions 216 to the second entity 204B. Details about the transmission of the first set of resolutions 216A to the second entity 204B are provided, for example, in FIG. 3 and FIG. 4.

At 614, the transmission of the first set of resolutions 216A to the first entity 204A is controlled. The transmission of the first set of resolutions 216A is controlled based on the detection of the transmission of the first set of resolutions 216A to the second entity 204B. In an embodiment of the disclosure, the computer system 202 is configured to control the transmission of the first set of resolutions 216A to the first entity 204A. Details about the control of the transmission of the first set of resolutions 216A to the first entity 204A are provided, for example, in FIG. 3 and FIG. 4.

While the above operations shown in FIG. 6 are described in a particular sequence, the operations may occur in variations to the sequence in accordance with various embodiments of the present disclosure. Further, details related to various operations of FIG. 6 which are already covered in the description related to FIG. 1, FIG. 2, FIG. 3, FIG. 4, FIG. 5A and FIG. 5B are not discussed again in detail here for the sake of brevity.

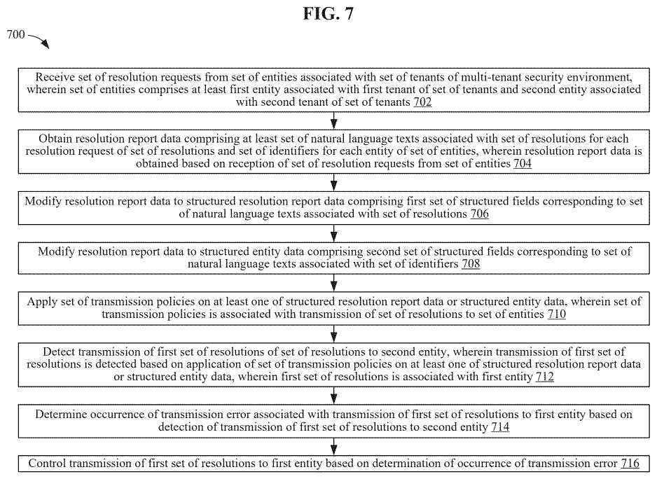

FIG. 7 is a diagram that illustrates a second flowchart 700 of a method for controlling transmission of data within a multi-tenant security environment, in accordance with an embodiment of the disclosure. FIG. 7 is explained in conjunction with elements from FIG. 1, FIG. 2, FIG. 3, FIG. 4, FIG. 5A, FIG. 5B, and FIG. 6. The operations of the method depicted by the second flowchart 700 may be executed by any computing system, for example, by the computer 102 of FIG. 1 or the computer system 202 of FIG. 2.

At 702, the set of resolution requests 212 is received from the set of entities 204 associated with the set of tenants 230 of the multi-tenant security environment 208. The set of entities 204 includes at least a first entity 204A associated with the first tenant 230A of the set of tenants 230 and the second entity 204B associated with the second tenant 230B of the set of tenants 230. In an embodiment of the disclosure, the computer system 202 is configured to receive the set of resolution requests 212 from the set of entities 204 associated with the set of tenants 230 of the multi-tenant security environment 208. Details about the reception of the set of resolution request 212 are provided, for example, in FIG. 3 and FIG. 4.

At 704, the resolution report data 214 is obtained. The resolution report data 214 includes at least the set of natural language texts associated with the set of resolutions 216 for each resolution request of the set of resolution requests 212 and the set of identifiers 218 for each entity of the set of entities 204. The resolution report data 214 is obtained based on the reception of the set of resolution requests from the set of entities 204. In an embodiment of the disclosure, the computer system 202 is configured to obtain the resolution report data 214. Details about the acquisition of the resolution report data 214 are provided, for example, in FIG. 3 and FIG. 4.

At 706, the resolution report data 214 is modified to the structured resolution report data 220. The structured resolution report data includes the first set of structured fields 222 corresponding to the set of natural language texts associated with the set of resolutions 216. In an embodiment of the disclosure, the computer system 202 is configured to modify the resolution report data 214 to the structured resolution report data 220. Details about the modification of the resolution report data 214 to the structured resolution report data 220 are provided, for example, in FIG. 3 and FIG. 4.

At 708, the resolution report data 214 is modified to the structured entity data 224. The structured entity data 224 includes the second set of structured fields 226 corresponding to the set of natural language texts associated with the set of identifiers 218. In an embodiment of the disclosure, the computer system 202 is configured to modify the resolution report data 214 to the structured entity data 224. Details about the modification of the resolution report data 214 to the structured entity data 224 are provided, for example, in FIG. 3 and FIG. 4.

At 710, the set of transmission policies 228 is applied on the at least one of the structured resolution report data 220 or the structured entity data 224. The set of transmission policies 228 is associated with the transmission of the set of resolutions 216 to the set of entities 204. In an embodiment of the disclosure, the computer system 202 is configured to apply the set of transmission policies 228 on the at least one of the structured resolution report data 220 or the structured entity data 224. Details about the application of the set of transmission policies 228 are provided, for example, in FIG. 3 and FIG. 4.

At 712, the transmission of the first set of resolutions 216A of the set of resolutions 216 to the second entity 204B is detected. The transmission of the first set of resolutions 216A is detected based on the application of the set of transmission policies 228 on the at least one of the structured resolution report data 220 or the structured entity data 224. The first set of resolutions 216A is associated with the first entity 204A. In an embodiment of the disclosure, the computer system 202 is configured to detect the transmission of the first set of resolutions 216A of the set of resolutions 216 to the second entity 204B. Details about the transmission of the first set of resolutions 216A to the second entity 204B are provided, for example, in FIG. 3 and FIG. 4.

At 714, the occurrence of the transmission error is determined based on the detection of the transmission of the first set of resolutions 216A to the second entity 204B. The transmission error is associated with the transmission of the first set of resolutions 216A to the first entity 204A. In an embodiment of the disclosure, the computer system 202 is configured to determine the occurrence of the transmission error based on the detection of the transmission of the first set of resolutions 216A to the second entity 204B. Details about the determination of the occurrence of the transmission error are provided, for example, in FIG. 3 and FIG. 4.

At 716, the transmission of the first set of resolutions 216A to the first entity 204A is controlled based on the determination of the occurrence of the transmission error. In an embodiment of the disclosure, the computer system 202 is configured to control the transmission of the first set of resolutions 216A to the first entity 204A based on the determination of the occurrence of the transmission error. Details about the control of the transmission of the first set of resolutions 216A to the first entity 204A are provided, for example, in FIG. 3 and FIG. 4.

While the above operations shown in FIG. 7 are described in a particular sequence, the operations may occur in variations to the sequence in accordance with various embodiments of the present disclosure. Further, details related to various operations of FIG. 7 which are already covered in the description related to FIG. 1, FIG. 2, FIG. 3, FIG. 4, FIG. 5A, FIG. 5B, and FIG. 6 are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, a set of resolution requests from a set of entities associated with a set of tenants of a multi-tenant security environment, wherein the set of entities comprises at least a first entity associated with a first tenant of the set of tenants and a second entity associated with a second tenant of the set of tenants;
obtaining, by the computer, resolution report data comprising at least a set of natural language texts associated with a set of resolutions for each resolution request of the set of resolution requests and a set of identifiers for each entity of the set of entities, wherein the resolution report data is obtained based on the reception of the set of resolution requests from the set of entities;
modifying, by the computer, the resolution report data to structured resolution report data comprising a first set of structured fields corresponding to the set of natural language texts associated with the set of resolutions;
modifying, by the computer, the resolution report data to structured entity data comprising a second set of structured fields corresponding to the set of natural language texts associated with the set of identifiers;
applying, by the computer, a set of transmission policies on at least one of the structured resolution report data or the structured entity data, wherein the set of transmission policies is associated with a transmission of the set of resolutions to the set of entities;
detecting, by the computer, a transmission of a first set of resolutions of the set of resolutions to the second entity, wherein the transmission of the first set of resolutions is detected based on the application of the set of transmission policies on the at least one of the structured resolution report data or the structured entity data, and wherein the first set of resolutions is associated with the first entity; and
controlling, by the computer, a transmission of the first set of resolutions to the first entity, wherein the transmission of the first set of resolutions is controlled based on the detection of the transmission of the first set of resolutions to the second entity.

2. The computer-implemented method of claim 1, further comprising:
determining, by the computer, an occurrence of a transmission error associated with the transmission of the first set of resolutions to the first entity based on the detection of the transmission of the first set of resolutions to the second entity; and
controlling, by the computer, the transmission of the first set of resolutions to the first entity based on the determination of the occurrence of the transmission error.

3. The computer-implemented method of claim 1, further comprising:
obtaining, by the computer, entity performance data for each entity of the set of entities based on the reception of the set of resolution requests from the set of entities;
determining, by the computer, an occurrence of a set of anomalies within each entity of the set of entities based on the obtained entity performance data;
applying, by the computer, a set of machine learning models on the set of anomalies and the obtained entity performance data; and
determining, by the computer, the resolution report data based on the application of the set of machine learning models on the set of anomalies and the obtained entity performance data.

4. The computer-implemented method of claim 3, wherein the obtained entity performance data comprises at least one of the set of identifiers for each entity of the set of entities, a processing time associated with each entity of the set of entities, an amount of memory usage associated with each entity of the set of entities, or a bandwidth associated with each entity of the set of entities.

5. The computer-implemented method of claim 3, further comprising:
applying, by the computer, the set of machine learning models on the resolution report data and the obtained entity performance data; and
modifying, by the computer, the resolution report data to the structured entity data based on the application of the set of machine learning models on the resolution report data and the obtained entity performance data.

6. The computer-implemented method of claim 1, further comprising:
applying, by the computer, a set of machine learning models on the resolution report data; and
modifying, by the computer, the resolution report data to the structured resolution report data based on the application of the set of machine learning models on the resolution report data.

7. The computer-implemented method of claim 1, wherein the first set of structured fields and the second set of structured fields are associated with a set of data formats, and wherein the set of data formats comprises at least one of a javascript object notation (JSON) format or an extensible markup language (XML) format.

8. The computer-implemented method of claim 1, wherein the first set of structured fields comprises at least one of a structured field for an identifier of a set of anomalies associated with each entity of the set of entities, a structured field for an identifier of the set of resolutions associated with each entity of the set of entities, a structured field for a timestamp of an occurrence of the set of anomalies associated with each entity of the set of entities, or a structured field for an identifier of a user associated with the set of resolution requests.

9. The computer-implemented method of claim 1, wherein the second set of structured fields comprises at least one of a structured field for an identifier of each entity of the set of entities, a structured field for an identifier of a respective tenant of each entity of the set of entities, or a structured field for an identifier of a location associated with each entity of the set of entities.

10. The computer-implemented method of claim 1, wherein the application of the set of transmission policies on the structured resolution report data comprising:
determining, by the computer, a set of request identifiers from a resolution request of the set of resolution requests, wherein the resolution request is associated with the second entity, and wherein the set of request identifiers is determined based on the transmission of the first set of resolutions to the second entity;
comparing, by the computer, a structured field of the first set of structured fields with a corresponding request identifier of the set of request identifiers, wherein the structured field of the first set of structured fields is associated with the first entity;
determining, by the computer, that the structured field of the first set of structured fields is different from the corresponding request identifier of the set of request identifiers based on the comparison of the structured field of the first set of structured fields with the corresponding request identifier of the set of request identifiers; and
detecting, by the computer, the transmission of the first set of resolutions to the second entity based on the determination that the structured field of the first set of structured fields is different from the corresponding request identifier of the set of request identifiers.

11. The computer-implemented method of claim 10, wherein the application of the set of transmission policies on the structured entity data comprising:
comparing, by the computer, a structured field of the second set of structured fields with the corresponding request identifier of the set of request identifiers, wherein the structured field of the second set of structured fields is associated with the first entity;
determining, by the computer, that the structured field of the second set of structured fields is different from the corresponding request identifier of the set of request identifiers based on the comparison of the structured field of the second set of structured fields with the corresponding request identifier of the set of request identifiers; and
detecting, by the computer, the transmission of the first set of resolutions to the second entity based on the determination that the structured field of the second set of structured fields is different from the corresponding request identifier of the set of request identifiers.

12. The computer-implemented method of claim 1, further comprising:
identifying, by the computer, a second set of resolutions from the set of resolutions based on the control of the transmission of the first set of resolutions to the first entity, wherein the second set of resolutions is associated with the second entity; and
controlling, by the computer, a transmission of the second set of resolutions to the second entity based on the identification of the second set of resolutions.

13. The computer-implemented method of claim 1, further comprising:
generating, by the computer, an alert based on the detection of the transmission of the first set of resolutions to the second entity.

14. A computer system, comprising:
a processor set;
one or more computer-readable storage media; and
program instructions stored on the one or more computer-readable storage media, the program instructions executable by the processor set to cause the processor set to:
receive a set of resolution requests from a set of entities associated with a set of tenants of a multi-tenant security environment, wherein the set of entities comprises at least a first entity associated with a first tenant of the set of tenants and a second entity associated with a second tenant of the set of tenants;
obtain resolution report data that comprises at least a set of natural language texts associated with a set of resolutions for each resolution request of the set of resolution requests and a set of identifiers for each entity of the set of entities, wherein the resolution report data is obtained based on the reception of the set of resolution requests from the set of entities;
modify the resolution report data to structured resolution report data that comprises a first set of structured fields corresponding to the set of natural language texts associated with the set of resolutions;
modify the resolution report data to structured entity data that comprises a second set of structured fields corresponding to the set of natural language texts associated with the set of identifiers;
apply a set of transmission policies on at least one of the structured resolution report data or the structured entity data, wherein the set of transmission policies is associated with a transmission of the set of resolutions to the set of entities;
detect a transmission of a first set of resolutions of the set of resolutions to the second entity, wherein the transmission of the first set of resolutions is detected based on the application of the set of transmission policies on the at least one of the structured resolution report data or the structured entity data, and wherein the first set of resolutions is associated with the first entity;
determine an occurrence of a transmission error associated with a transmission of the first set of resolutions to the first entity based on the detection of the transmission of the first set of resolutions to the second entity; and
control the transmission of the first set of resolutions to the first entity based on the determination of the occurrence of the transmission error.

15. The computer system of claim 14, wherein the program instructions further cause the processor set to:
obtain entity performance data for each entity of the set of entities based on the reception of the set of resolution requests from the set of entities;
determine an occurrence of a set of anomalies within each entity of the set of entities based on the obtained entity performance data;
apply a set of machine learning models on the set of anomalies and the obtained entity performance data; and
determine the resolution report data based on the application of the set of machine learning models on the set of anomalies and the obtained entity performance data.

16. The computer system of claim 15, wherein the obtained entity performance data comprises at least one of the set of identifiers for each entity of the set of entities, a processing time associated with each entity of the set of entities, an amount of memory usage associated with each entity of the set of entities, or a bandwidth associated with each entity of the set of entities.

17. The computer system of claim 15, wherein the program instructions further cause the processor set to:
apply the set of machine learning models on the resolution report data and the obtained entity performance data; and
modify the resolution report data to the structured entity data based on the application of the set of machine learning models on the resolution report data and the obtained entity performance data.

18. The computer system of claim 14, wherein the program instructions further cause the processor set to:
apply a set of machine learning models on the resolution report data; and
modify the resolution report data to the structured resolution report data based on the application of the set of machine learning models on the resolution report data.

19. The computer system of claim 14, wherein the first set of structured fields and the second set of structured fields are associated with a set of data formats, and wherein the set of data formats comprises at least one of a javascript object notation (JSON) format or an extensible markup language (XML) format.

20. A computer program product for controlling transmission of data within a multi-tenant security environment, the computer program product comprising:
one or more computer-readable storage media; and
program instructions stored on the one or more computer-readable storage media to perform operations comprising:
receiving a set of resolution requests from a set of entities associated with a set of tenants of the multi-tenant security environment, wherein the set of entities comprises at least a first entity associated with a first tenant of the set of tenants and a second entity associated with a second tenant of the set of tenants;
obtaining resolution report data comprising at least a set of natural language texts associated with a set of resolutions for each resolution request of the set of resolution requests and a set of identifiers for each entity of the set of entities, wherein the resolution report data is obtained based on the reception of the set of resolution requests from the set of entities;
modifying the resolution report data to structured resolution report data comprising a first set of structured fields corresponding to the set of natural language texts associated with the set of resolutions;
modifying the resolution report data to structured entity data comprising a second set of structured fields corresponding to the set of natural language texts associated with the set of identifiers;
applying a set of transmission policies on at least one of the structured resolution report data or the structured entity data, wherein the set of transmission policies is associated with a transmission of the set of resolutions to the set of entities;
detecting a transmission of a first set of resolutions of the set of resolutions to the second entity, wherein the transmission of the first set of resolutions is detected based on the application of the set of transmission policies on the at least one of the structured resolution report data or the structured entity data, and wherein the first set of resolutions is associated with the first entity; and
controlling a transmission of the first set of resolutions to the first entity, wherein the transmission of the first set of resolutions is controlled based on the detection of the transmission of the first set of resolutions to the second entity.
